(19) United States
(12) Patent Application Publication
(10) Pub. No.: US 2023/0146661 A1
(43) Pub. Date: May 11, 2023

(54) SYSTEM AND METHOD OF DETERMINING FOULING LOCATION OF SHELL AND TUBE HEAT EXCHANGER

(71) Applicants: KING FAHD UNIVERSITY OF PETROLEUM AND MINERALS, Dhahran (SA); Yokogawa Saudi Arabia Company, Al-Khobar (SA)

(72) Inventors: Sami EL-FERIK, Dhahran (SA); Mustafa AL-NASER, Al-Khobar (SA); Rached Ben MANSOUR, Dhahran (SA); Mohammed Ahmed Mohammed Eltoum Mohammed ALI, Dhahran (SA)

(73) Assignees: KING FAHD UNIVERSITY OF PETROLEUM AND MINERALS, Dhahran (SA); Yokogawa Saudi Arabia Company, Al-Khobar (SA)

(21) Appl. No.: 17/982,615

(22) Filed: Nov. 8, 2022

Related U.S. Application Data
(60) Provisional application No. 63/276,898, filed on Nov. 8, 2021.

(51) Int. Cl. G01N 17/00; F28F 27/02

(52) U.S. Cl. CPC G01N 17/008; F28F 27/02

(57) ABSTRACT

A method of determining a fouling location of a shell and tube heat exchanger is provided. Under the method, a simulation model of the heat exchanger is partitioned into multiple segments. Each segment corresponds to a different one of multiple operating scenarios of the heat exchanger. For each operating scenario, temperature data and pressure drop data are generated from the simulation model of the heat exchanger. The fouling location of the heat exchanger corresponds to a respective segment in each of the multiple operating scenarios. The temperature data and the pressure drop data are classified based on the multiple segments of the simulation model by inputting the temperature data and the pressure drop data to one or more machine learning classification algorithms. The fouling location and a value of accumulated fouling at the fouling location are determined based on the classified temperature data and the classified pressure drop data.

### CROSS-REFERENCE TO RELATED APPLICATION

This present application claims the benefit of priority to U.S. Provisional Application No. 63/276,898, “INTELLIGENT PREDICTION APPROACH OF FOULING LOCATION IN SHELL AND TUBE HEAT EXCHANGER,” filed on Nov. 8, 2021, which is incorporated by reference herein in its entirety.

### STATEMENT REGARDING PRIOR DISCLOSURE BY INVENTORS

Aspects of the present disclosure were described in M. Al-Naser, S. El-Ferik, R. B. Mansour, H. Y. AlShammari, and A. AlAmoudi, “Intelligent Prediction Approach of Fouling Location in Shell and Tube Heat Exchanger,” 2020 IEEE 10th International Conference on System Engineering and Technology (ICSET), 2020, pp. 139-144, incorporated herein by reference in its entirety.

### BACKGROUND

### Technical Field

The present disclosure is directed to heat exchangers and maintenance thereof, and more particularly to a method and a system of determining a fouling location of a shell and tube heat exchanger.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Heat exchanger is a key process unit for many industrial processes, and is used widely for a wide range of applications. Fouling in a heat exchanger, which appears on inner surfaces of the heat exchanger, has a negative impact on the operational efficiency of the heat transfer, and is responsible for the increase in energy consumption, production cost, and greenhouse gases emission, especially in refinery applications [See: E. Diaz-Bejarano, E. Behranvand, F. Coletti, M. R. Mozdianfard, and S. Macchietto, “Organic and Inorganic Fouling in Heat Exchangers: Industrial Case Study Analysis of Fouling Rate,” Ind. Eng. Chem. Res., vol. 58, No. 1, pp. 228-246, 2019]. The fouling increases the thermal resistance of the heat exchanger due to low thermal conductivity of the foulant deposit and increases pressure drop which may lead to an unexpected shutdown of the heat exchanger. Fouling build-up phenomenon is one of the most challenging problems for heat exchangers in the industry, leading to a degradation of system efficiency, an increase of production cost, and a harmful environmental impact.

Some estimates put the losses due to the fouling of heat exchangers in industrialized nations to be about 0.25% of their GDP [See: BI. Master, K S Chunangad, V Pushpanathan. Fouling mitigation using helixchanger heat exchangers; and H Mueller-Steinhagen, M R Malayeri, AP Watkinson. Fouling of heat exchanger-New approaches to solve old problem. Heat Transfer Engineering, 2005;26 (2)]. According to Harwell Laboratories, 15% of maintenance cost of the process plant is related to heat exchangers and boilers, of which half of the cost may probably be caused by the fouling. Maintenance cost could be attributed to chemicals used for removing the fouling, mechanical antifouling devices, and the replacement of corroded or plugged equipment. Typical cleaning costs of a heat exchanger are in the range of $40,000 to $50,000 per cleaning [See: H. Ibrahim., “Fouling in Heat Exchangers” in MATLAB A Fundamental Tool for Scientific Computing and Engineering Applications—Volume 3. Vasilios Katsikis IntechOpen, UK, 2012].

In the recent years, some progress has been made in the fundamental understanding of the process leading to the fouling and the practice of the industry, including the process of the maintenance and the use of antifoulants [See: S. Macchietto et al., “Fouling in crude oil preheat trains: A systematic solution to an old problem,” Heat Transf. Eng., vol. 32, No. 3-4, pp. 197-215, 2011; S. Macchietto, “Energy efficient heat exchange in fouling conditions: the UNIHEAT Project,” presented at the Int. Conf. Heat Exchanger Fouling and Cleaning—2015, Enfield (Dublin), Ireland, Jun. 7—12, 2015; and E. F. C. Somerscales, “Fouling of heat transfer surfaces an historical review,” Heat Transf. Eng., vol. 11, No. 1, pp. 19-36, 1990]. The fouling usually occurs over a period while the equipment is running until the fouling reaches to an impermissible level which requires a shutdown of the equipment to perform cleaning. So, heat exchanger asset performance solutions should be able to monitor the current conditions, predict the performance, and identify the root cause of performance degradation [See: P. Vijaysai; Mark D. Osborn; Shirley S. Au; K. Ravi Chandra Reddy; Sunil S. Shah; P Nishith. Vora; Anthony Gryscavage, Predictive Performance Assessment of Heat Exchangers for Proactive Remediation. 2006 IEEE International Conference on Industrial Technology]. Some condition monitoring solutions have been used in industry to monitor and assess the health of the heat exchangers. However, there is a room for further improvement, especially in the design of the heat exchanger, condition monitoring, and preventive maintenance solutions.

Recently, artificial intelligence has been employed as a promising technique to monitor and predict the fouling. Al-Naser et al. (2019) [See: M. Al-Naser, M. Al-Toum, S. El-Ferik, R. Ben Mansour, F. Al-Sunni “Heat Exchanger Fouling Prediction Using Artificial Intelligence” 5th International Conference on Advances in Mechanical Engineering Istanbul, 17-19 December used Artificial Neural Networks (ANN) to estimate the fouling and dynamic ANN namely Long Short-Term Memory (LSTM) to predict the fouling. Sunder et al. (2020) [See: S. Sundar, C. Manjunath. R. H. Zhao, G. Kuntumalla, Y. Meng, H. C. Chang, C. Shao, P. Ferreira, N. Miljkovic. “Fouling modeling and prediction approach for heat exchangers using deep learning” International Journal of Heat and Mass Transfer, vol. 159, 2020] developed a model based on deep learning to predict the fouling which can be adopted to various types of heat exchangers. Abd-Elhady et al. (2009) [See: A. D. Sanjiv Sinha, Srinivasa Salapaka, M. S. Abd-Elhady, C. C. M Rindt, and. A. A Van Steenhoven 2007. “Optimization of Flow Direction to Minimize Particulate Fouling of Heat Exchangers,” Proc. of 7th International Conference on Heat Exchanger Fouling and Cleaning—Challenges and Opportunities. Vol RPS, Article 46] investigated the effect of the flow direction with respect to gravity to determine the optimal flow direction in order to minimize the fouling. It has generally been observed that the fouling starts at points of stagnation regardless of the flow direction, and at the top of the tube of the heat exchanger. Also, it has been observed that the fouling grows from these points until the fouling covers the whole surface of the tube. Further, it has been observed that the fouling is formed at a higher rate in the upper surface of the tube than the lower one, and the fouling is also higher in the lower tube section than the upper one. So, it may be concluded that the fouling is not uniform across the heat exchanger which makes it necessary to determine a fouling location in order to plan appropriate maintenance actions therefor.

However, there is no efficient process available that can determine the fouling location inside the heat exchanger. So, there is a need for intelligent approaches which can utilize existing measurement to infer the fouling location in the heat exchanger, especially a shell and tube heat exchanger which is a widely used type of heat exchanger, and is disproportionally prone to the fouling. Accordingly, it is an object of the present disclosure to provide a method and a system of determining a fouling location of a shell and tube heat exchanger using artificial intelligence techniques.

### SUMMARY

Aspects of the disclosure provide a method of determining a fouling location of a shell and tube heat exchanger. The method comprises partitioning a simulation model of the heat exchanger into multiple segments. Herein, each of the multiple segments corresponds to a different one of multiple operating scenarios of the heat exchanger. The method further comprises generating, for each of the multiple operating scenarios, temperature data and pressure drop data from the simulation model of the heat exchanger. Herein, the fouling location of the heat exchanger corresponds to a respective segment in each of the multiple operating scenarios. The method further comprises classifying the temperature data and the pressure drop data based on the multiple segments of the simulation model of the heat exchanger by inputting the temperature data and the pressure drop data to one or more machine learning classification algorithms. The method further comprises determining the fouling location of the heat exchanger and a value of accumulated fouling at the fouling location based on the classified temperature data and the classified pressure drop data.

In one embodiment, the one or more machine learning classification algorithms includes at least one of a k-nearest neighbors algorithm, a decision tree algorithm, or a discriminant algorithm.

In one embodiment, the temperature data is for at least one of a tube side or a shell side of the heat exchanger, and the pressure drop data is for the tube side of the heat exchanger.

In one embodiment, each of the multiple segments corresponds to one different class in the one or more machining learning classification algorithms.

In one embodiment, the generating includes changing a tube inner diameter and a heat transfer coefficient of one of the multiple segments corresponding to the fouling location to generate the value of the accumulated fouling at the fouling location. Further, the generating includes keeping tube inner diameters and heat transfer coefficients of other segments unchanged.

In one embodiment, the determining includes determining the fouling location of the heat exchanger and the value of the accumulated fouling at the fouling location based on features extracted from a dynamic response of the simulation model of the heat exchanger.

In one embodiment, the dynamic response of the simulation model is obtained by inputting a step or sinusoidal form of an input signal that is a gas flow rate, a tube inlet temperature, or a shell inlet temperature.

In one embodiment, the features extracted from the dynamic response of the simulation model include at least one of a rate of change, a time constant, an amplitude ratio, a phase shift, or output harmonics of an output signal of the simulation model.

In one embodiment, the output signal is a tube outlet temperature, a shell outlet temperature, or a tube pressure drop.

In one embodiment, the features extracted from the dynamic response of the simulation model are generated by feeding an entire output signal of the simulation model to a deep learning algorithm.

Aspects of the disclosure also provide an apparatus for determining a fouling location of a shell and tube heat exchanger. The apparatus comprises processing circuitry. The processing circuitry is configured to partition a simulation model of the heat exchanger into multiple segments, each of the multiple segments corresponding to a different one of multiple operating scenarios of the heat exchanger. The processing circuitry is further configured to generate, for each of the multiple operating scenarios, temperature data and pressure drop data from the simulation model of the heat exchanger, the fouling location of the heat exchanger corresponding to a respective segment in each of the multiple operating scenarios. The processing circuitry is further configured to classify the temperature data and the pressure drop data based on the multiple segments of the simulation model of the heat exchanger by inputting the temperature data and the pressure drop data to one or more machine learning classification algorithms; and determine the fouling location of the heat exchanger and a value of accumulated fouling at the fouling location based on the classified temperature data and the classified pressure drop data.

In one embodiment, the one or more machine learning classification algorithms includes at least one of a k-nearest neighbors algorithm, a decision tree algorithm, or a discriminant algorithm.

In one embodiment, the temperature data is for at least one of a tube side or a shell side of the heat exchanger, and the pressure drop data is for the tube side of the heat exchanger.

In one embodiment, each of the multiple segments corresponds to one different class in the one or more machining learning classification algorithms.

In one embodiment, the processing circuitry is also configured to change a tube inner diameter and a heat transfer coefficient of one of the multiple segments corresponding to the fouling location to generate the value of the accumulated fouling at the fouling location. The processing circuitry is further configured to keep tube inner diameters and heat transfer coefficients of other segments unchanged.

In one embodiment, the processing circuitry is also configured to determine the fouling location of the heat exchanger and the value of the accumulated fouling at the fouling location based on features extracted from a dynamic response of the simulation model of the heat exchanger.

In one embodiment, the dynamic response of the simulation model is obtained by inputting a step or sinusoidal form of an input signal that is a gas flow rate, a tube inlet temperature, or a shell inlet temperature.

In one embodiment, the features extracted from the dynamic response of the simulation model include at least one of a rate of change, a time constant, an amplitude ratio, a phase shift, or output harmonics of an output signal of the simulation model.

In one embodiment, the output signal is a tube outlet temperature, a shell outlet temperature, or a tube pressure drop.

In one embodiment, the features extracted from the dynamic response of the simulation model are generated by feeding an entire output signal of the simulation model to a deep learning algorithm.

Aspects of the disclosure further provide a non-transitory computer-readable storage medium. The non-transitory computer-readable storage medium stores a program executable by at least one processor to perform: partitioning a simulation model of a heat exchanger into multiple segments, each of the multiple segments corresponding to a different one of multiple operating scenarios of the heat exchanger; generating, for each of the multiple operating scenarios, temperature data and pressure drop data from the simulation model of the heat exchanger, the fouling location of the heat exchanger corresponding to a respective segment in each of the multiple operating scenarios; classifying the temperature data and the pressure drop data based on the multiple segments of the simulation model of the heat exchanger by inputting the temperature data and the pressure drop data to one or more machine learning classification algorithms; and determining the fouling location of the heat exchanger and a value of accumulated fouling at the fouling location based on the classified temperature data and the classified pressure drop data.

In one embodiment, the one or more machine learning classification algorithms includes at least one of a k-nearest neighbors algorithm, a decision tree algorithm, or a discriminant algorithm.

In one embodiment, the temperature data is for at least one of a tube side or a shell side of the heat exchanger, and the pressure drop data is for the tube side of the heat exchanger.

In one embodiment, each of the multiple segments corresponds to one different class in the one or more machining learning classification algorithms.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an illustration of a flowchart of a method of determining a fouling location of a shell and tube heat exchanger, according to certain embodiments.

FIG. 2 is a schematic of a simulation model of the heat exchanger, according to certain embodiments.

FIG. 3 is a graph showing tube outlet temperature versus fouling for scenarios where fouling accumulates in a single location, according to certain embodiments.

FIG. 4 is a graph showing tube outlet temperature versus fouling for scenarios where fouling accumulates in two locations, according to certain embodiments.

FIG. 5 is a graph showing the tube outlet temperature difference in percentage versus the fouling, according to certain embodiments.

FIG. 6 is a graph showing the tube outlet temperature difference in percentage versus the fouling, according to certain embodiments.

FIG. 7 is a graph showing the tube outlet temperature difference in percentage versus the fouling, according to certain embodiments.

FIG. 8 is a graph showing the tube outlet temperature difference in percentage versus the fouling, according to certain embodiments.

FIG. 9 is a graph showing the tube outlet temperature difference in percentage versus the fouling, according to certain embodiments.

FIG. 10 is a graph showing shell outlet temperature versus fouling for scenarios where fouling accumulates in a single location, according to certain embodiments.

FIG. 11 is a graph showing shell outlet temperature versus fouling for scenarios where fouling accumulates in two locations, according to certain embodiments.

FIG. 12 is a graph showing the shell outlet temperature difference in percentage versus the fouling, according to certain embodiments.

FIG. 13 is a graph showing the shell outlet temperature difference in percentage versus the fouling, according to certain embodiments.

FIG. 14 is a graph showing the shell outlet temperature difference in percentage versus the fouling, according to certain embodiments.

FIG. 15 is a graph showing the shell outlet temperature difference in percentage versus the fouling, according to certain embodiments.

FIG. 16 is a graph showing the shell outlet temperature difference in percentage versus the fouling, according to certain embodiments.

FIG. 17 is a graph showing tube pressure drop versus fouling for scenarios where fouling accumulates in a single location, according to certain embodiments.

FIG. 18 is a graph showing tube pressure drop versus fouling for scenarios where fouling accumulates in two locations, according to certain embodiments.

FIG. 19 is a graph showing tube pressure drop difference in percentage versus the fouling, according to certain embodiments.

FIG. 20 is a graph showing the tube pressure drop difference in percentage versus the fouling, according to certain embodiments.

FIG. 21 is a graph showing the tube pressure drop difference in percentage versus the fouling, according to certain embodiments.

FIG. 22 is a graph showing the tube pressure drop difference in percentage versus the fouling, according to certain embodiments.

FIG. 23 is a graph showing the tube pressure drop difference in percentage versus the fouling, according to certain embodiments.

FIG. 24 is a schematic block diagram of a classification architecture to predict the fouling location in the heat exchanger, according to certain embodiments.

FIG. 25 is an illustration of a non-limiting example of details of an apparatus for determining a fouling location of a shell and tube heat exchanger, according to certain embodiments.

FIG. 26 is an exemplary schematic diagram of a data processing system used within the computing system, according to certain embodiments.

FIG. 27 is an exemplary schematic diagram of a processor used with the computing system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to determining a fouling location in a heat exchanger, for example a shell and tube heat exchanger. The present disclosure implements simulation and artificial intelligence based techniques to achieve the said purpose. Specifically, the present disclosure provides details about building a multi-segments heat exchanger model of the heat exchanger using a simulator application in order to simulate working of the heat exchanger and to determine the fouling location thereby. The present disclosure also provides techniques to analyze generated data using the said model to draw inferences about impact of the fouling location on the heat exchanger's outlet streams; which is shown to provide that the closer the fouling is to the heat exchanger outlet, the higher the impact on the outlet stream measurements. The present disclosure further provides an artificial intelligence model built in order to estimate the fouling location using the said measurements.

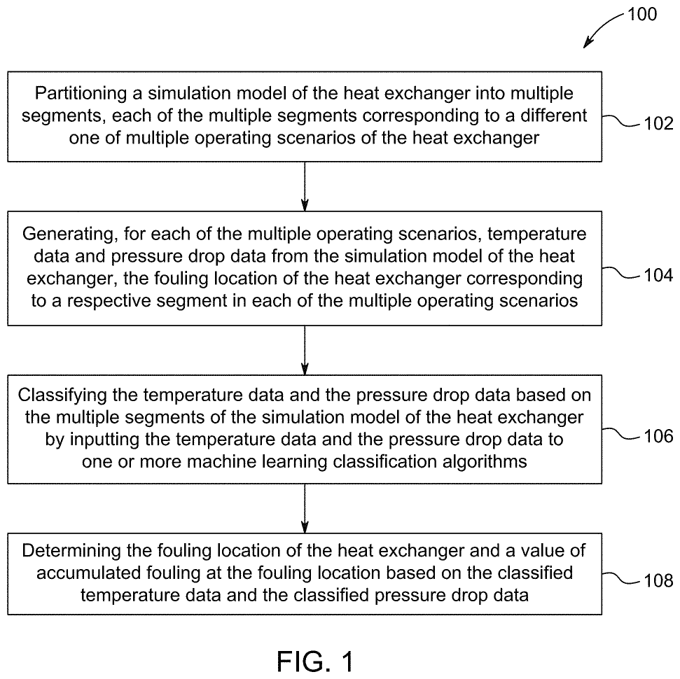

Referring to FIG. 1, illustrated is a flowchart of a method (represented by reference numeral 100) of determining a fouling location of a shell and tube heat exchanger, in accordance with certain embodiments. As used herein, the shell and tube heat exchanger is a type of heat exchanging device constructed using a large cylindrical enclosure, or shell, that has bundles of spaced tubes arranged and compacted inside thereof. One fluid runs through the tubes, and another fluid flows over the tubes (through the shell) to transfer heat between the two fluids. Heat may be transferred from one fluid to the other through the tube walls, either from tube side to shell side or vice versa. The fluids may be single or two phases, and may flow in a parallel or a cross/counter flow arrangement. The shell and tube heat exchangers are the most common form of heat exchange design and are suited for higher-pressure applications, and thus provide an ideal solution for a wide variety of applications including, but not limited to, cooling of hydraulic fluid and oil in engines, transmissions and hydraulic power packs, oil refineries, and other large chemical processes.

In various applications, heat exchangers are susceptible to fouling, especially when operating in challenging conditions or handling difficult materials such as sewage and wastewater sludges. Fouling in relation to heat exchangers can be defined as deposition and accumulation of unwanted material such as scale, suspended solids, insoluble salts and even algae on the internal surfaces of the heat exchanger. Different types of fouling may affect the heat exchangers. Chemical fouling, or scaling, occurs when chemical changes within the fluid cause a fouling layer to be deposited onto the tube surface. Biological fouling is caused by the growth of organisms, such as algae, within the fluid that deposit onto the surfaces of the heat exchanger. Deposition fouling (also known as sedimentation fouling) occurs when particles contained within the fluid settle onto the surface, usually when the fluid's velocity falls below a critical level. Corrosion fouling occurs when a layer of corrosion products builds up on the surfaces of the tube, forming an extra layer of material that often has thermal resistance.

Fouling has a significant impact on heat transfer across the heat exchanger surface, and therefore on the overall operational performance and the economics of the process. The shell and tube heat exchanger with its multiple tubes design is especially prone to fouling. The buildup of fouling reduces the cross-sectional area of the tubes or flow channels, and increases the resistance of the fluid passing over the surface. These side effects combine to increase the pressure drop across the shell and tube heat exchanger, reducing flow rates and aggravating the problem further.

The present method 100 can determine a fouling location in the shell and tube heat exchanger. It can be appreciated that steps described hereinafter in reference to the method 100 are only illustrative, and other alternatives may also be provided where one or more steps are re-ordered, one or more steps are added, or one or more steps are removed without departing from the spirit and the scope of the present disclosure. Further, although the embodiments of the present disclosure have been described in terms of the heat exchanger being the shell and tube heat exchanger; it would be appreciated by a person skilled in the art that teachings of the present method 100 can be applied to other types of heat exchangers with or without any modifications as may be contemplated, without departing from the spirit and the scope of the present disclosure. Thereby, the terms “shell and tube heat exchanger” and “heat exchanger” have been interchangeably used hereinafter without any limitations.

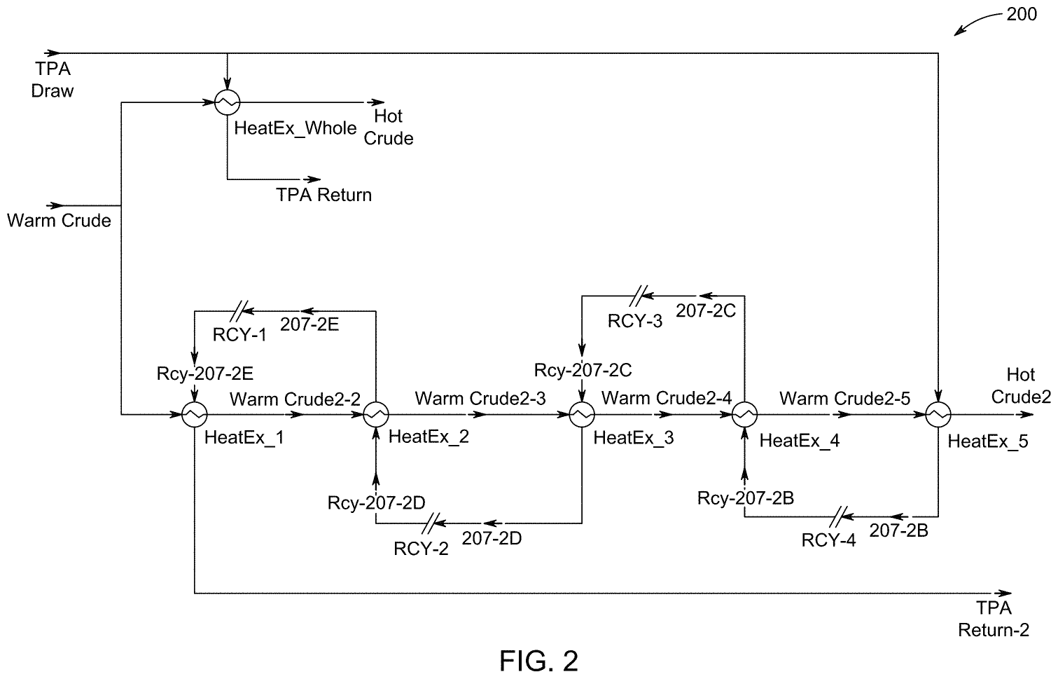

At step 102, the method 100 includes partitioning a simulation model of the heat exchanger into multiple segments, with each of the multiple segments corresponding to a different one of multiple operating scenarios of the heat exchanger. For this purpose, the method 100 includes first generating the simulation model of the heat exchanger. Referring to FIG. 2, illustrated is the simulation model of the heat exchanger (as represented by reference numeral 200) implemented for the purposes of the present disclosure. Hereinafter, the said simulation model of the heat exchanger has been simply referred to as “simulation model” without any limitations. For present purposes, the simulation model 200 can be built using a simulator application such as PetroSlM®, which is an industrial process simulator application. It can be understood that the use of such simulator application to build the simulation model 200 is beyond the scope of the present disclosure but would be contemplated by a person skilled in the art, and thus has not been described herein.

In the present embodiments, the simulation model 200 is built using parameters listed in Table 1 below. Herein, the simulation model 200 can simulate the effect of fouling location in the heat exchanger, specifically on outlet measurements, namely tube outlet temperature, shell outlet temperature, and tube pressure drop of the heat exchanger.

TABLE 1
Heat Exchanger Parameters

| Parameter | Value |
|---|---|
| Shell inner diameter | 1176 mm |
| Tube inner diameter | 18.59 mm |
| Tube outer diameter | 25.40 mm |
| Number of Shell Passes | 1 |
| Number of tubes | 876 |
| Tube Length | 6 m |
| Shell fluid inlet temperature | 80° C. |
| Tube fluid inlet temperature | 20° C. |
| Shell fluid mass flow rate | 2.010 × 10⁵ Kg/h |
| Tube fluid mass flow rate | 1.391 × 10⁵ Kg/h |

According to embodiments of the present disclosure, the heat exchanger is partitioned into multiple segments in the simulation model 200. A number of the multiple segments can affect the accuracy of the fouling location. The higher number of the multiple segments, the more accurate fouling location is, and the more complex the simulation model is. Thus, a selection of the number of the multiple segments can be based on a trade-off between the accuracy of the fouling location and the complexity of the simulation model. In an embodiment, the number of the multiple segments is selected to be 5 as an example. That is, as shown in FIG. 2, the simulation model 200 is divided into five segments, namely HeatEx_1 (also referred to as “segment 1”), HeatEx_2 (also referred to as “segment 2”), HeatEx_3 (also referred to as “segment 3”), HeatEx_4 (also referred to as “segment 4”), and HeatEx_5 (also referred to as “segment 5”). Herein, each of the multiple segments corresponds to a different one of multiple operating scenarios of the heat exchanger. In an example, as shown in FIG. 2, the HeatEx_1 (segment 1) can correspond to a segment proximal to an inlet of the heat exchanger, the HeatEx_2 (segment 2) can be further to the inlet and closer to the outlet of the heat exchanger as compared to the segment 1, and so on, with the HeatEx_5 (segment 5) being farthest from the inlet and proximal most to the outlet of the heat exchanger. Further, in the present examples, five operating scenarios are conducted; and in each of the operating scenarios, only the corresponding segment is assumed to be fouled (i.e., only one segment is assumed to be fouled at a time). It can be understood that the employed simulator application is used to simulate different operating scenarios to analyze the effect of fouling at different locations in the heat exchanger.

At step 104, the method 100 includes generating, for each of the multiple operating scenarios, temperature data and pressure drop data from the simulation model 200 of the heat exchanger, with the fouling location of the heat exchanger corresponding to a respective segment in each of the multiple operating scenarios. In an embodiment, the generating includes changing a tube inner diameter and a heat transfer coefficient of one of the multiple segments corresponding to the fouling location to generate the value of the accumulated fouling at the fouling location. Further, the generating includes keeping tube inner diameters and heat transfer coefficients of other segments unchanged. That is, in the present embodiments, in order to perform fouling simulation for the heat exchanger, the tube inner diameter and the heat transfer coefficient for a specific segment are changed while keeping other parameters at their nominal value for each operating scenario. Herein, the simulation model 200 is implemented by changing the tube inner diameter of the heat exchanger to simulate the impact of fouling on heat transfer, specifically to simulate the effect of the fouling on pressure drop and the heat transfer coefficient. In the present examples, the simulation was performed assuming that the fouling was generated as an asymptotic fouling pattern.

It is noted that a number of samples (or cases) used in each operating scenario can affect performance of a prediction model that is used to determine the fouling location of the heat exchanger. The higher number of the samples used in each operating scenario, the better performance of the prediction model.

In an embodiment, the number of the samples (or cases) used in each operating scenario can be selected around 400. For example, in the simulation, 400 cases for each of the five operating scenarios are conducted, and the outlet measurements are collected for each such case. For example, in each sample (or case), the inner diameter of the tube and the heat transfer coefficient can be varied. The fouling in the simulation can start from zero fouling (i.e., no fouling happens) and then increase gradually. In the present examples, the value of heat transfer coefficient and the tube inner diameter are gradually changed using the following equations:

ID=(OD−2TH) (1)

wherein, ‘ID’ is the tube inner diameter (in mm), ‘OD’ is the tube outer diameter (mm), and ‘TH’ is the tube total thickness (in mm). And,

$${U}_{d} = \frac{1}{\frac{1}{U} + {R}_{f}} \qquad ( 2 )$$

wherein, ‘U_{d}’ is the heat transfer coefficient after fouling (kcal/h-m²-C), ‘U’ is the heat transfer coefficient of clean heat exchanger (kcal/h-m²-C), and ‘R_{f}’ is the fouling factor (C-hr-m²/kcal).

In the present embodiments, the temperature data (generated as a result of the simulation, as described in the preceding paragraphs) includes at least one of tube outlet temperature data or shell outlet temperature data of the heat exchanger. Such temperature data is correlated to the fouling of the heat exchanger and thus can be utilized to determine the fouling location in the heat exchanger (as described hereinafter). The data generated from the simulation model can be categorized into two groups. The first group includes 5 scenarios (scenarios 1-5) where the fouling happens in a single segment while the second group includes 2 scenarios (scenarios 6-7) where the fouling occurs in two segments. In scenario 6, the fouling happens in segments 1 and 3. In scenario 7, the fouling happens in segments 3 and 5.

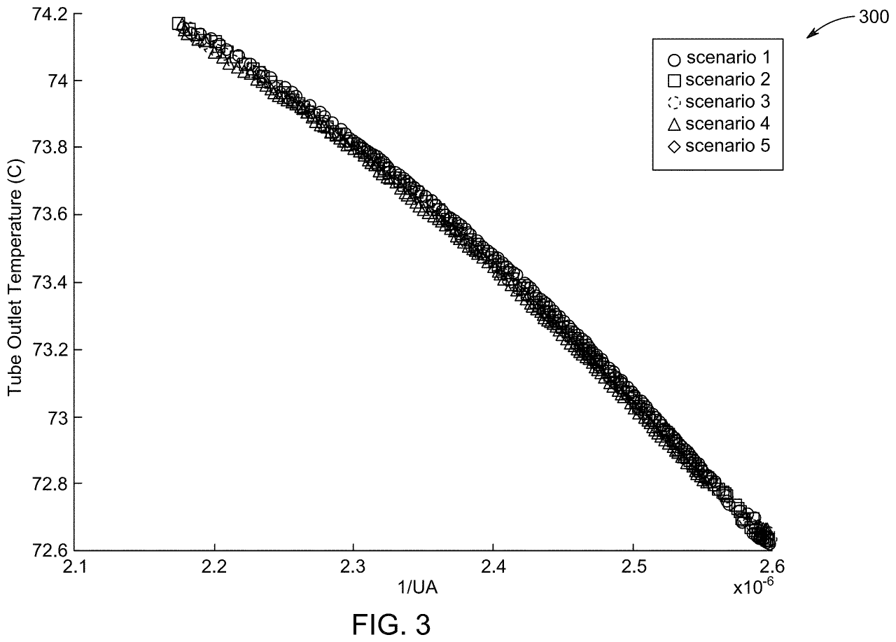

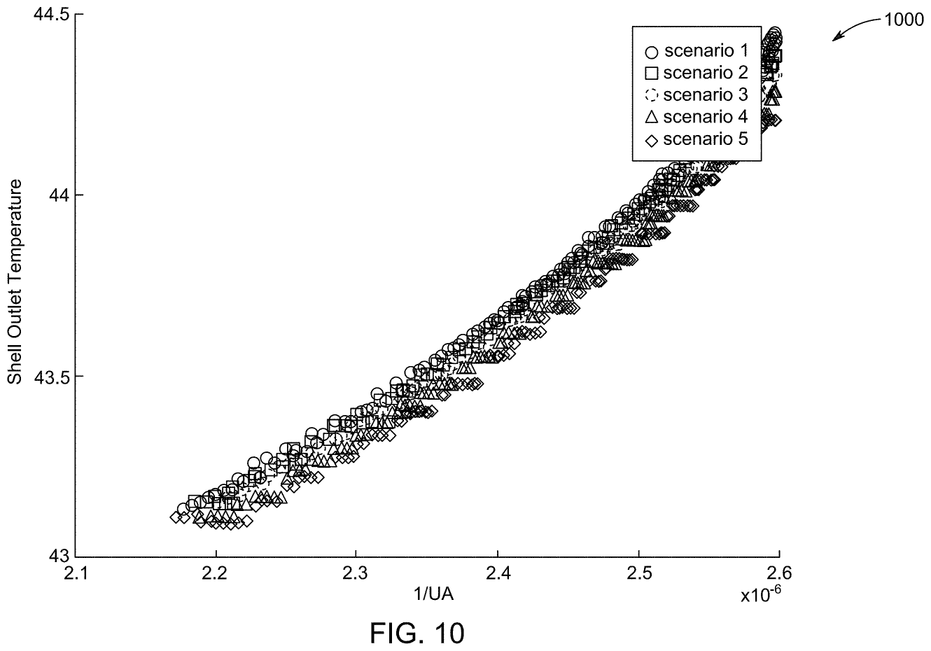

Referring now to FIGS. 3 to 16, illustrated are different graphical representations showing the results for simulating the heat exchanger (i.e., the temperature data) for the seven scenarios (i.e., scenarios 1-7). Specifically, FIGS. 3 to 9 illustrate graphical representations showing relationship between the tube outlet temperature and the fouling (as represented by “1/UA”) of the heat exchanger, and FIGS. 10 to 16 illustrate graphical representations showing relationship between the shell outlet temperature data and the fouling of the heat exchanger. In the measurement, 1/UA represented the inverse of the heat transfer coefficient.

FIG. 3 illustrates a graph (as represented by reference numeral 300) showing the tube outlet temperature versus the fouling for scenarios 1-5 where fouling accumulates in a single location (obtained as the results from the simulation model 200 of the heat exchanger). It can be seen that the tube outlet temperature keeps on decreasing as the value of the fouling increases.

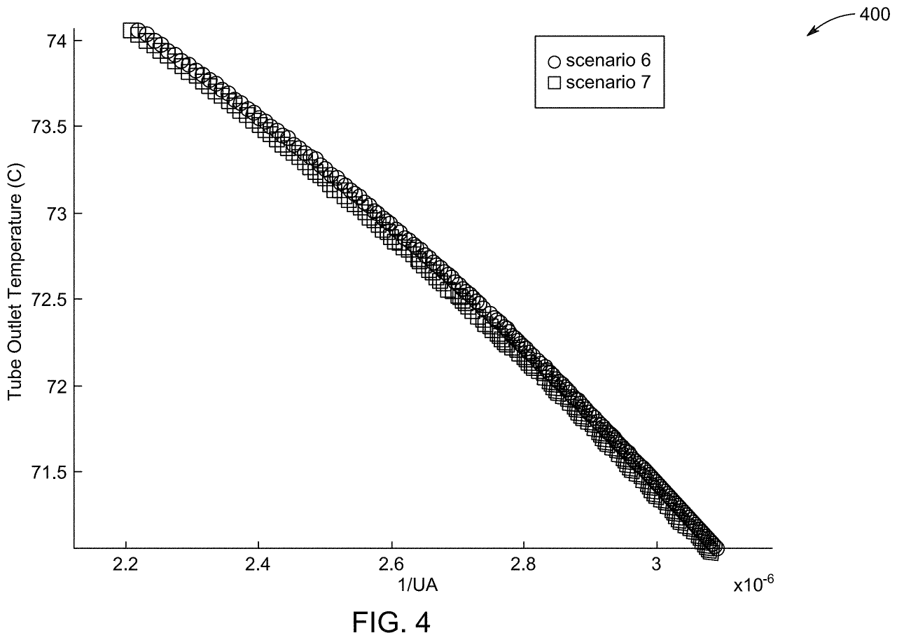

FIG. 4 illustrates a graph (as represented by reference numeral 400) showing tube outlet temperature versus fouling for scenarios 6-7 where fouling accumulates in two locations. It can be seen that the tube outlet temperature keeps on decreasing as the value of the fouling increases.

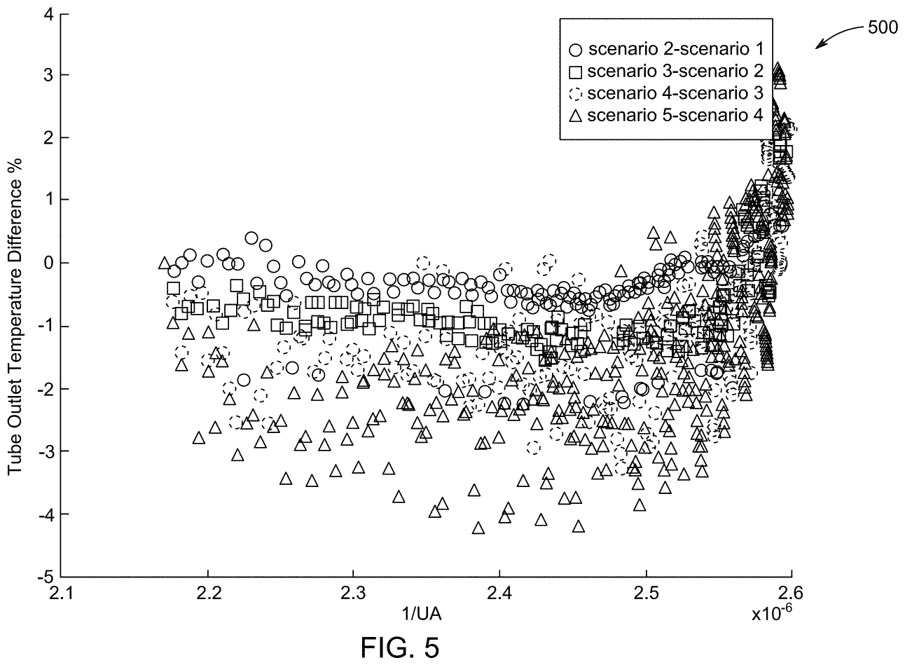

FIG. 5 illustrates a graph (as represented by reference numeral 500) showing the tube outlet temperature difference in percentage among scenarios 1-5 versus the fouling. The following observation can be made from the graph 500. For ‘scenario 2—scenario 1’, the difference is almost zero, which does not provide a good indication about the effect of the fouling location. However, for ‘scenario 5-scenario 4’, the difference is comparatively clearer, which means that it is easier to identify the fouling location if it happens at the segments closer to the outlets of the heat exchanger.

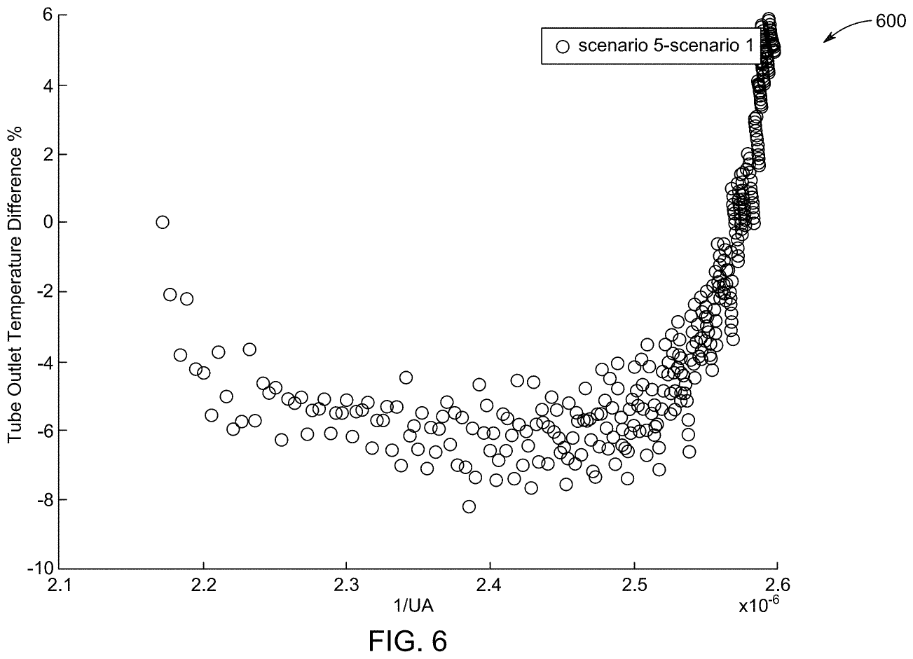

FIG. 6 illustrates a graph (as represented by reference numeral 600) showing the tube outlet temperature difference in percentage between ‘scenario 5’ and ‘scenario 1’ (i.e., ‘scenario 5-scenario 1’) versus the fouling. It can be seen that there is a significant temperature difference (about 6%) between scenarios 5 and 1 compared to the temperature differences among other scenarios. Therefore, this measurement can be used to determine whether the fouling location is at a beginning (proximal to inlet) or at an end (proximal to outlet) of the heat exchanger. Specifically, it can be observed that at higher values of the fouling, the effect is clearer. However, it can be appreciated that usually such high values of the fouling in the heat exchanger may generally not be allowed for safety reasons.

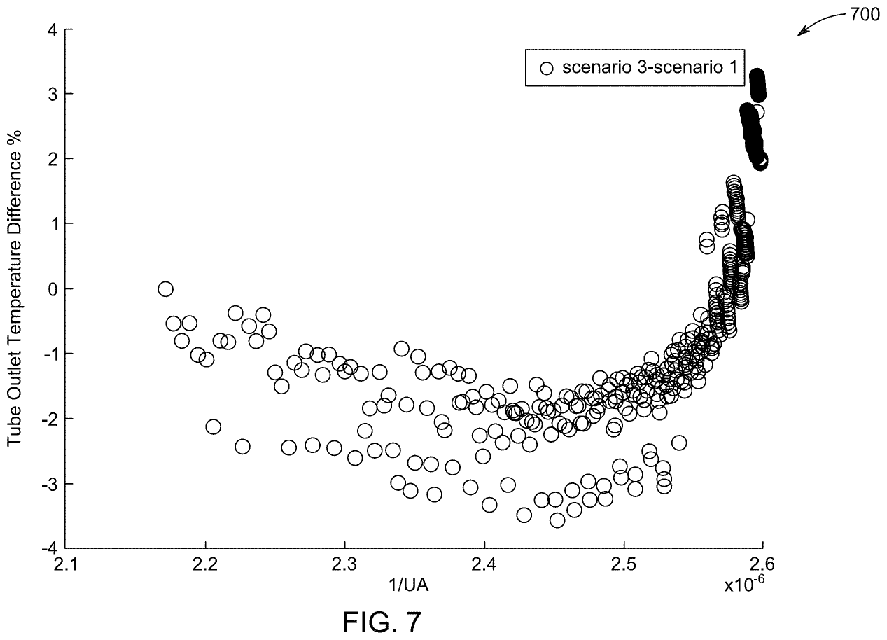

FIG. 7 illustrates a graph (as represented by reference numeral 700) showing the tube outlet temperature difference in percentage between scenario 3 and scenario 1 (i.e., ‘scenario 3-scenario 1’) versus the fouling.

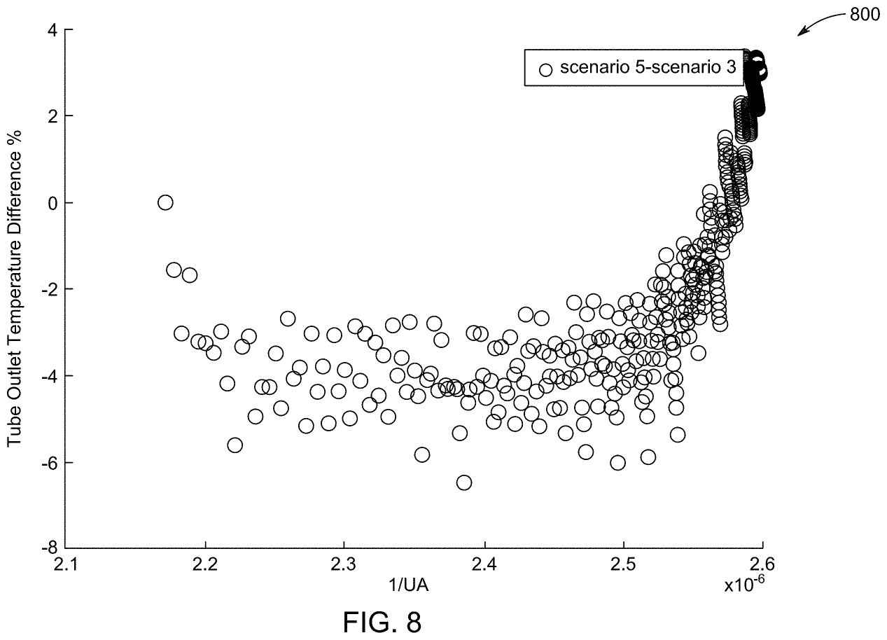

FIG. 8 illustrates a graph (as represented by reference numeral 800) showing the tube outlet temperature difference in percentage between scenario 5 and scenario 3 (i.e., ‘scenario 5-scenario 3’) versus the fouling.

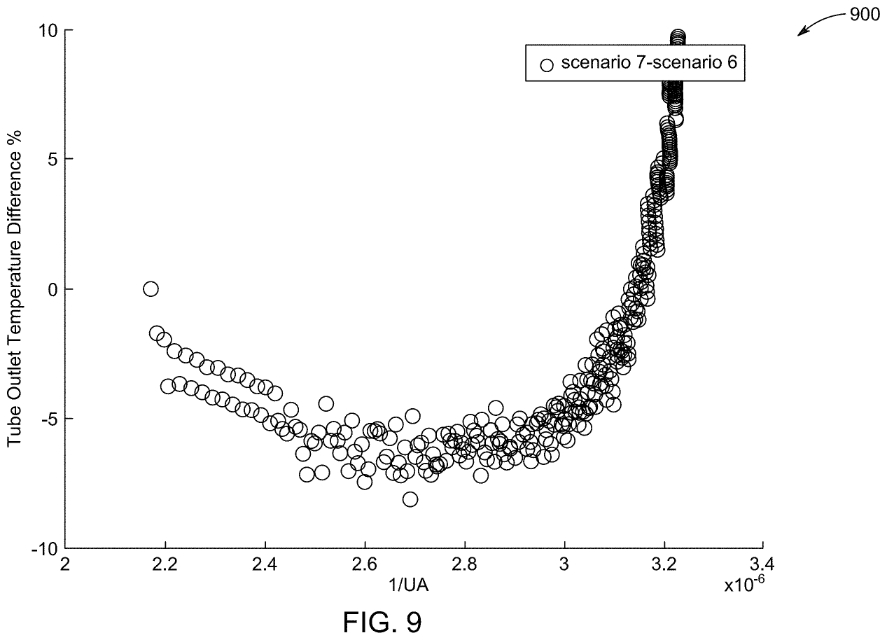

FIG. 9 illustrates a graph (as represented by reference numeral 900) showing the tube outlet temperature difference in percentage between scenario 7 and scenario 6 (i.e., ‘scenario 7-scenario 6’) versus the fouling.

It can be seen from the graphs 500-900 that the temperature difference (about 6%) between scenario 5 and scenario 1 and the temperature difference (about 6%) between scenario 7 and scenario 6 are more clear and significant than the temperature differences among other scenarios. Specifically, it may be observed that at lower values of the fouling, the effect is clearer. This effect can be used to at least estimate if the fouling location is at a beginning (proximal to inlet) or at an end (proximal to outlet) of the heat exchanger.

Further, similar observations can be made using the shell outlet temperature.

FIG. 10 illustrates a graph (as represented by reference numeral 1000) showing the shell outlet temperature versus the fouling for scenarios 1-5 where fouling accumulates in a single location (obtained as the results from the simulation model 200 of the heat exchanger). It can be seen that the shell outlet temperature keeps on increasing as the value of the fouling increases. It can be observed that the effect of the fouling on the shell outlet temperature (as shown in the graph 1000) may be slightly clear (at least as compared to the effect of the fouling on the tube outlet temperature in the graph 300).

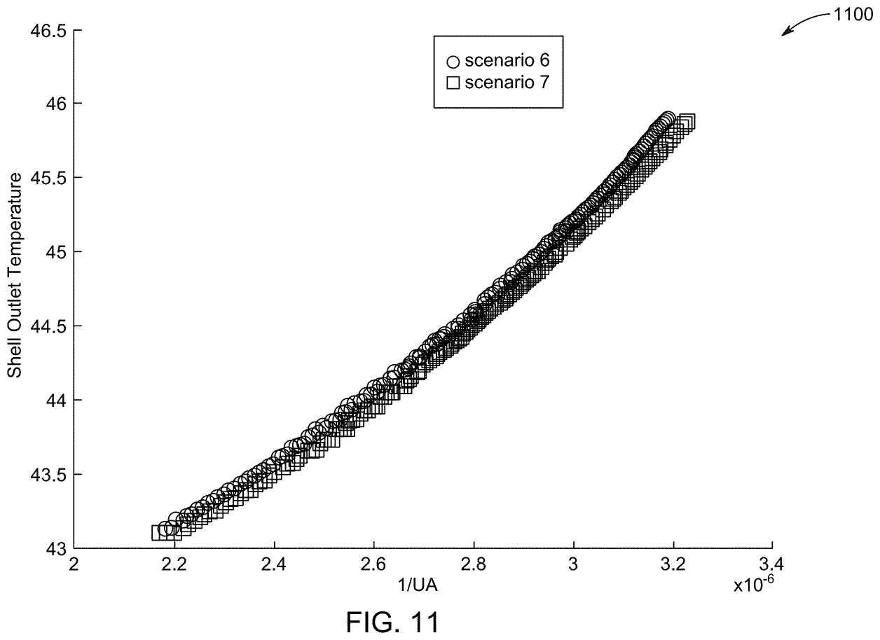

FIG. 11 illustrates a graph (as represented by reference numeral 1100) showing the shell outlet temperature versus the fouling for scenarios 6-7 where fouling accumulates in two locations. It can be seen that the shell outlet temperature keeps on increasing as the value of the fouling increases.

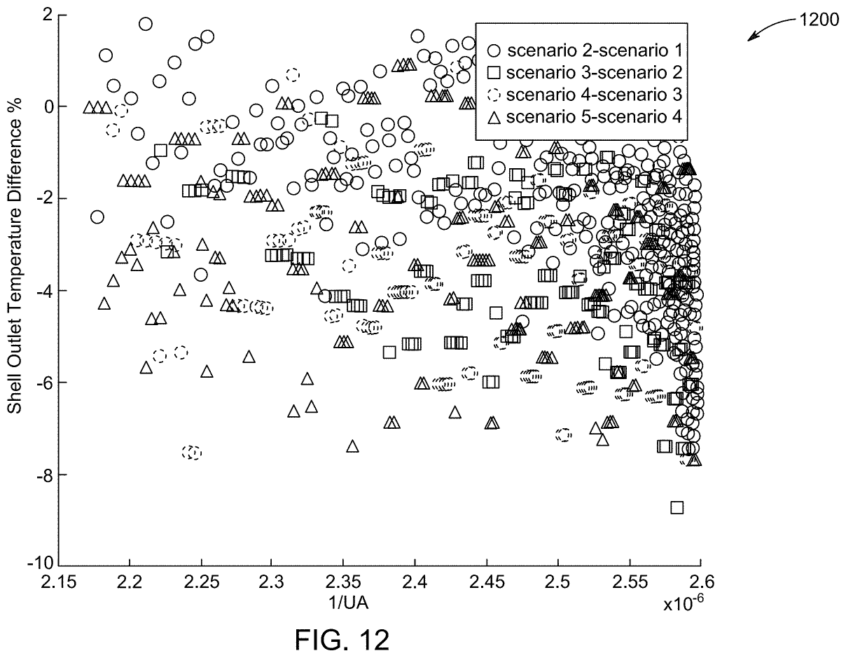

FIG. 12 illustrates a graph (as represented by reference numeral 1200) showing the shell outlet temperature difference in percentage among scenarios 1-5 versus the fouling. The following observation can be made from the graph 1200. For ‘scenario 2-scenario 1’, the difference is almost zero, which does not provide a good indication about the effect of the fouling location. However, for ‘scenario 5-scenario 4’, the difference is comparatively clearer, which means that it is easier to identify the fouling location if it happens at the segments closer to the outlets of the heat exchanger.

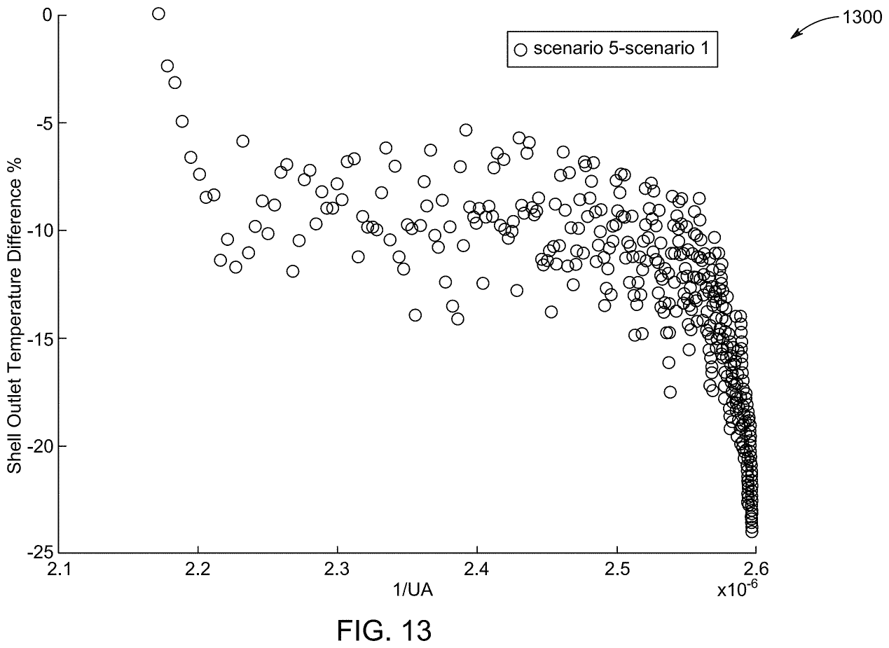

FIG. 13 illustrates a graph (as represented by reference numeral 1300) showing the shell outlet temperature difference in percentage between ‘scenario 5’ and ‘scenario 1’ (i.e., ‘scenario 5-scenario 1’) versus the fouling.

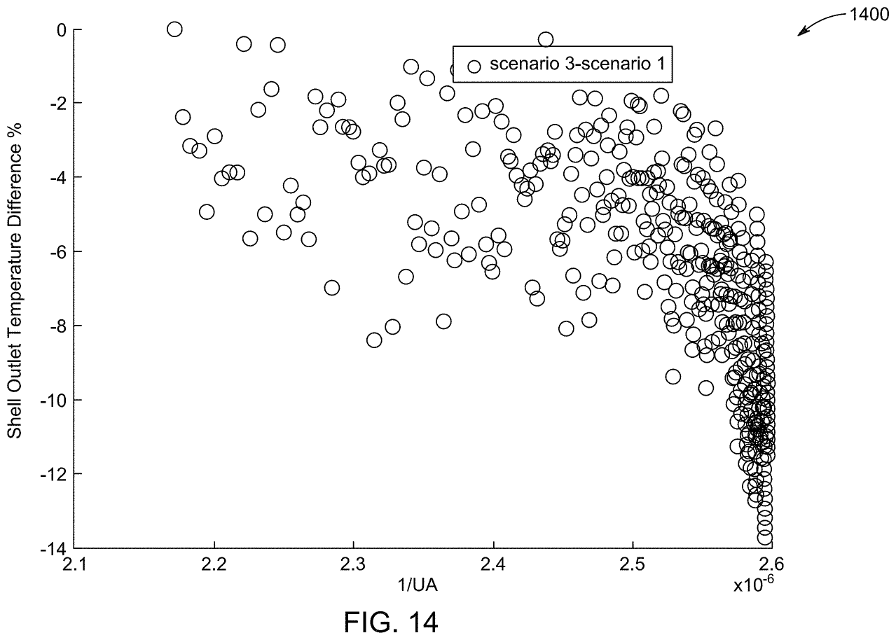

FIG. 14 illustrates a graph (as represented by reference numeral 1400) showing the shell outlet temperature difference in percentage between scenario 3 and scenario 1 (i.e., ‘scenario 3-scenario 1’) versus the fouling.

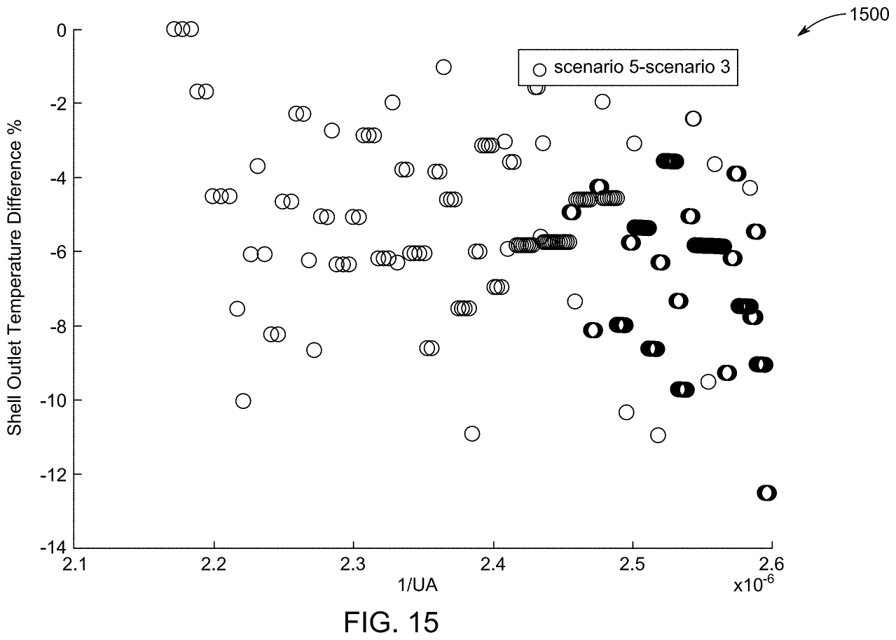

FIG. 15 illustrates a graph (as represented by reference numeral 1500) showing the shell outlet temperature difference in percentage between scenario 5 and scenario 3 (i.e., ‘scenario 5-scenario 3’) versus the fouling.

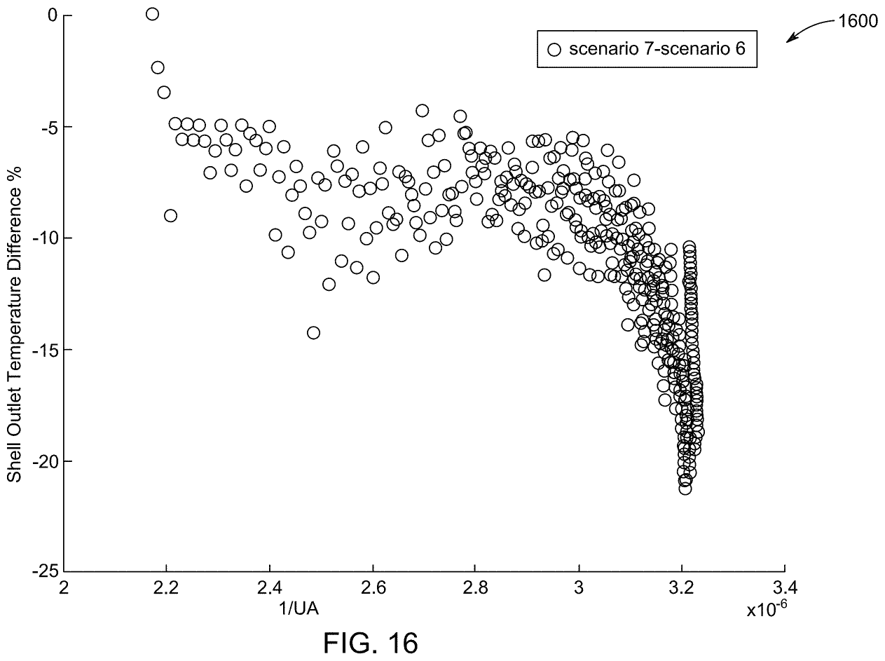

FIG. 16 illustrates a graph (as represented by reference numeral 1600) showing the shell outlet temperature difference in percentage between scenario 7 and scenario 6 (i.e., ‘scenario 7-scenario 6’) versus the fouling.

It can be seen from the graphs 1300-1600 that the temperature difference (about 10%) between scenario 5 and scenario 1 and the temperature difference (about 10%) between scenario 7 and scenario 6 are more clear and significant than other temperature differences. Specifically, it can be observed that at lower values of the fouling, the effect is clearer. This effect can be used to at least estimate if the fouling location is at a beginning (proximal to inlet) or at an end (proximal to outlet) of the heat exchanger.

To summarize, the following observations can be made from the graphs of FIGS. 3 to 16. The impact of the fouling is clearer on the tube outlet temperature if the fouling occurs at the segments close to the outlet of the heat exchanger. For example, if the fouling location is in the segment 4 or segment 5, it can be easily distinguishable and thus be determined, in contrast to say if the fouling location is in the segment 1 or the segment 2 of the simulation model 200. Similar conclusions can be made from the shell outlet temperature of the heat exchanger. In fact, the impact of the fouling on the shell outlet temperature can be even clearer than the tube outlet temperature. Thus, the tube outlet temperature and the shell outlet temperature of the heat exchanger can be used to determine if the fouling location is at the beginning or at the end of the heat exchanger.

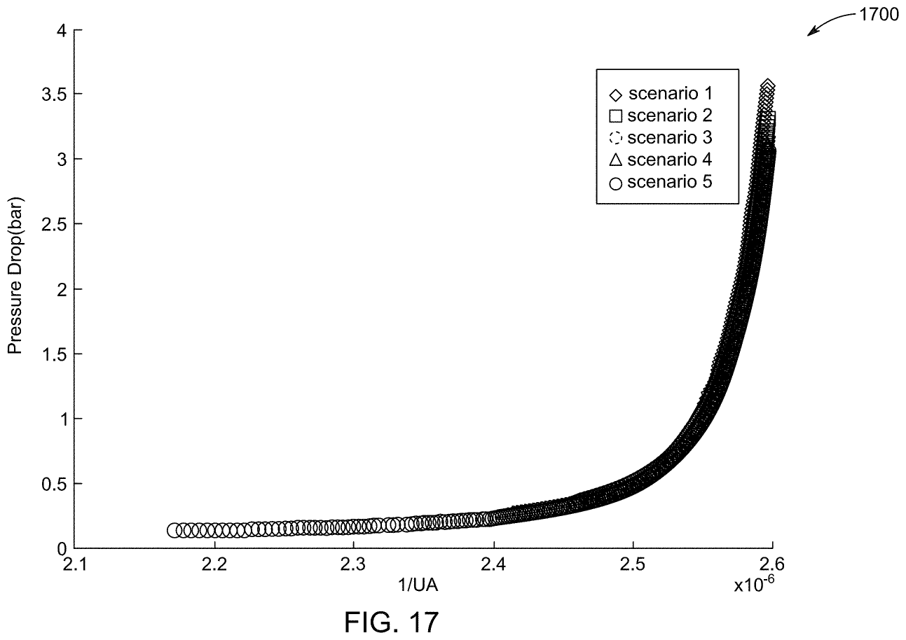

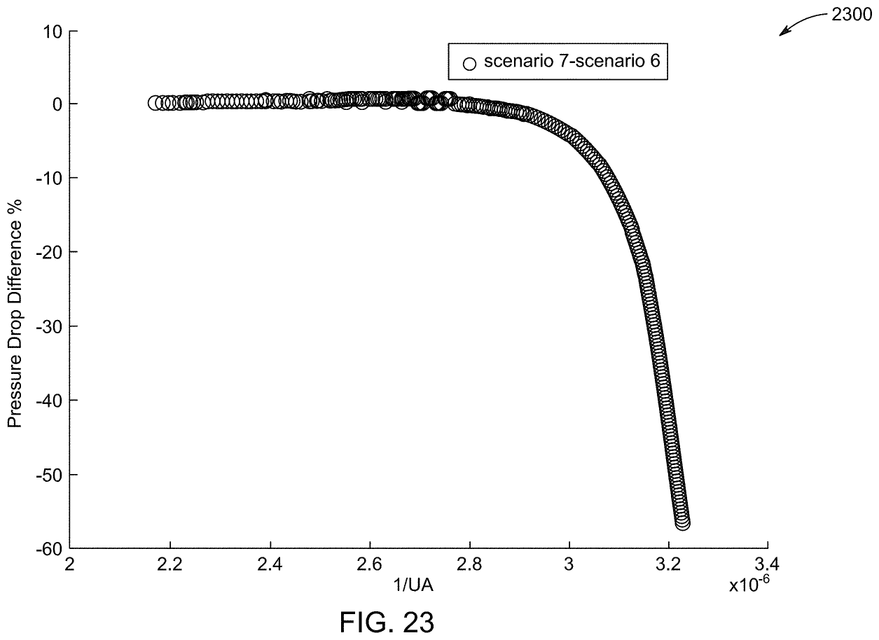

Furthermore, the simulation results show that the tube pressure drop is also correlated to the fouling of the heat exchanger. Referring now to FIGS. 17 and 23, illustrated are different graphical representations showing the results for simulating heat exchanger (i.e., the tube pressure drop) for the seven scenarios (i.e., scenarios 1-7).

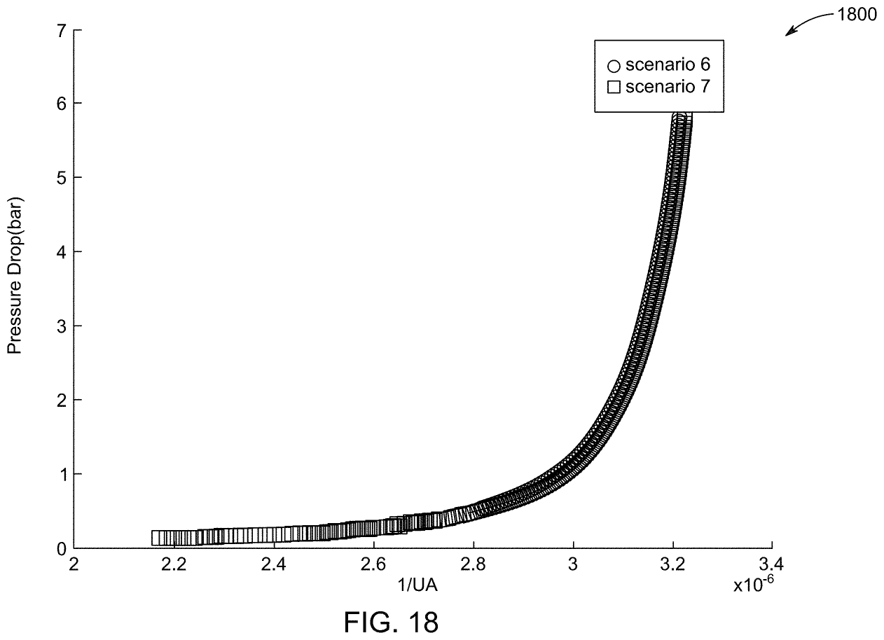

FIG. 17 illustrates a graph (as represented by reference numeral 1700) showing tube pressure drop versus fouling for scenarios 1-5 where fouling accumulates in a single location. It can be seen that the tube pressure drop keeps on increasing as the value of the fouling increases. FIG. 18 illustrates a graph (as represented by reference numeral 1800) showing tube pressure drop versus fouling for scenarios 6-7 where fouling accumulates in two locations. It can be seen that the tube pressure drop keeps on increasing as the value of the fouling increases.

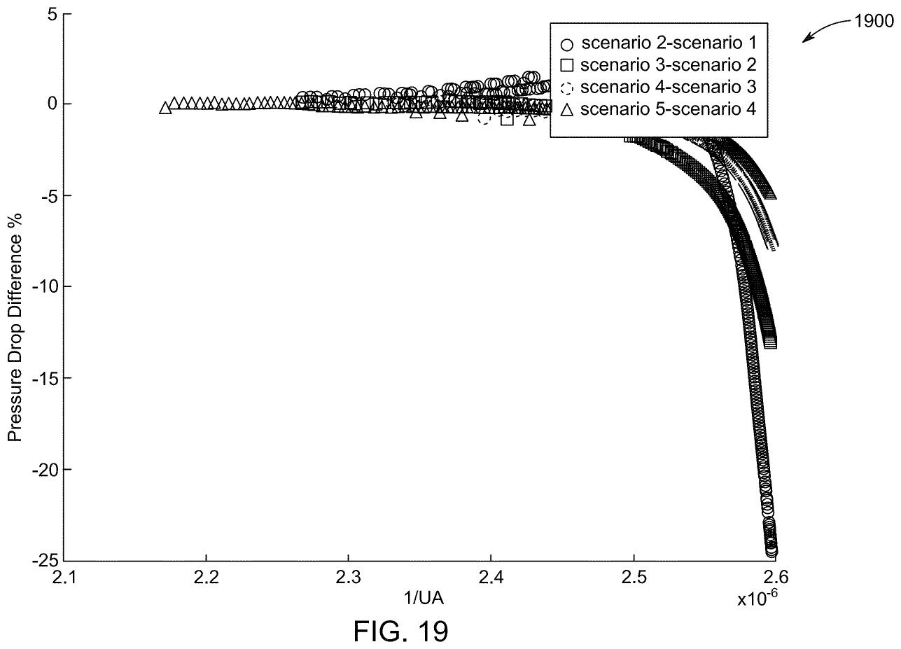

FIG. 19 illustrates a graph (as represented by reference numeral 1900) showing the tube pressure drop difference in percentage among scenarios 1-5 versus the fouling.

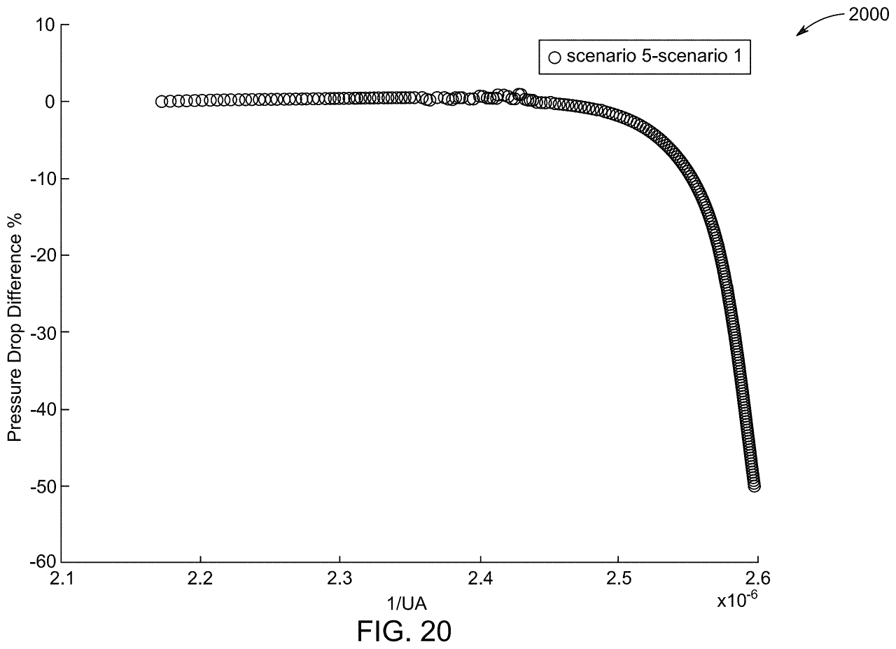

FIG. 20 illustrates a graph (as represented by reference numeral 2000) showing the tube pressure drop difference in percentage between ‘scenario 5’ and ‘scenario 1’ (i.e., ‘scenario 5-scenario 1’) versus the fouling. It can be observed that the impact of the fouling on the tube pressure drop is not significant to infer the fouling location except at very high values of the fouling. Thus, the tube pressure drop values can also be utilized to determine the fouling location in the heat exchanger, in an example.

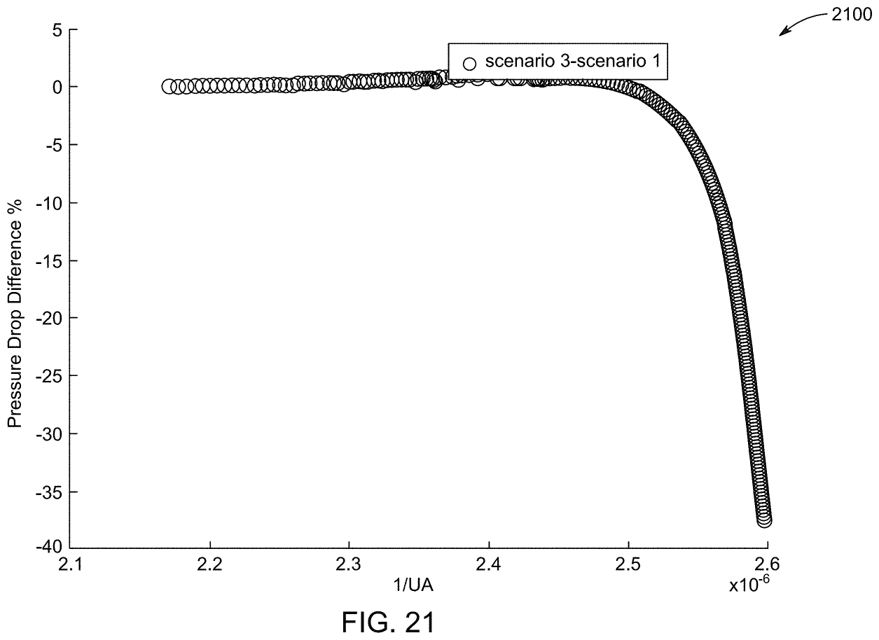

FIG. 21 illustrates a graph (as represented by reference numeral 2100) showing the tube pressure drop difference in percentage between ‘scenario 3’ and ‘scenario 1’ (i.e., ‘scenario 3-scenario 1’) versus the fouling.

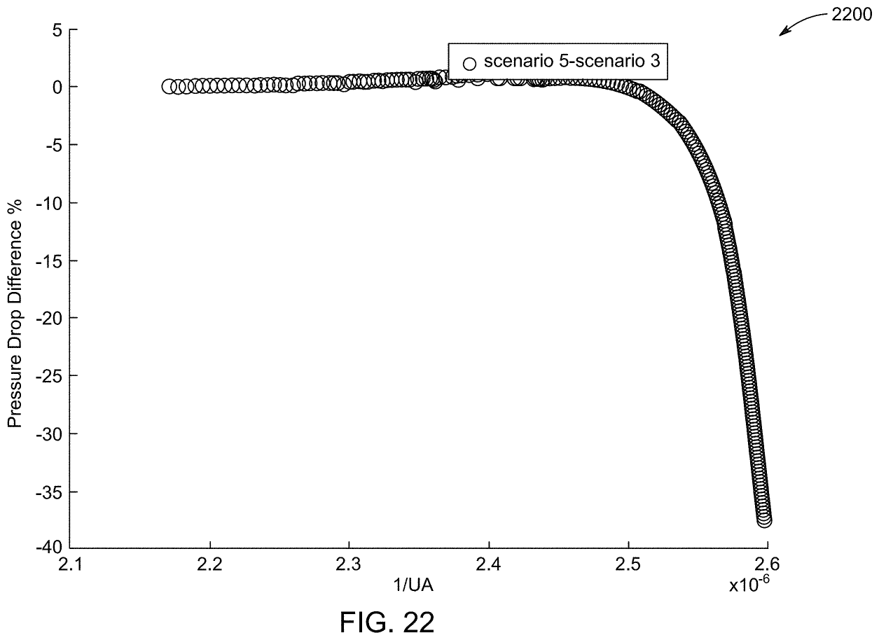

FIG. 22 illustrates a graph (as represented by reference numeral 2200) showing the tube pressure drop difference in percentage between ‘scenario 5’ and ‘scenario 3’ (i.e., ‘scenario 5-scenario 3’) versus the fouling.

FIG. 23 illustrates a graph (as represented by reference numeral 2300) showing the tube pressure drop difference in percentage between ‘scenario 7’ and ‘scenario 6’ (i.e., ‘scenario 7-scenario 6’) versus the fouling.

Referring back to FIG. 1, at step 106, the method 100 includes classifying the temperature data and the pressure drop data based on the multiple segments of the simulation model of the heat exchanger by inputting the temperature data and the pressure drop data to one or more machine learning classification algorithms.

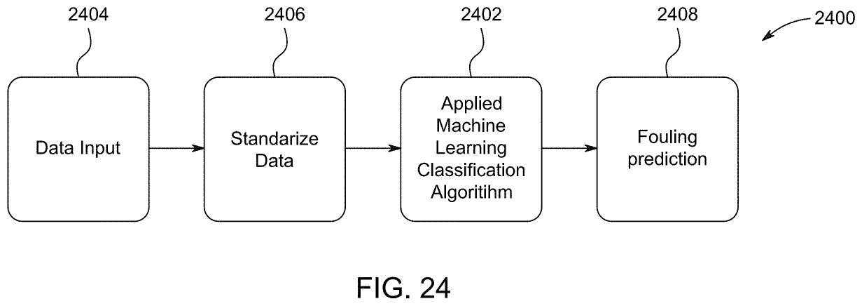

FIG. 24 illustrates a schematic block diagram of a classification architecture (as represented by reference numeral 2400) showing processes involved in implementation of an applied machine learning classification algorithm (as represented by block 2402 in FIG. 24) therein, to predict the fouling location in the heat exchanger. In an example, the applied machine learning classification algorithm 2402 may be executed in MATLAB 2020a; however, other suitable computing environments may alternatively be utilized without any limitations.

In the classification architecture 2400, the applied machine learning classification algorithm 2402 utilizes the temperature data and the pressure drop data generated from the simulation model 200 as data input (as represented by block 2404 in FIG. 24). Specifically, the temperature data and the pressure drop data generated from the simulation model 200 for different operating scenario are used as the data input 2404, as shown in Table 2 below. In an embodiment, the number of samples used in each operating scenario is 400. In an example, the data input is standardized (as represented by block 2406 in FIG. 24) before being fed to the applied machine learning classification algorithm 2402. Such standardization techniques (also known as normalization techniques) may be contemplated by a person skilled in the art and thus have not been described herein for the brevity of the present disclosure.

TABLE 2
Fouling location in each scenario

| Scenario No. | Fouling Location | No. of Samples |
|---|---|---|
| Scenario 1 | segment 1 | 400 |
| Scenario 2 | segment 2 | 400 |
| Scenario 3 | segment 3 | 400 |
| Scenario 4 | segment 4 | 400 |
| Scenario 5 | segment 5 | 400 |

As discussed, the temperature data, including the tube outlet temperature and the shell outlet temperature, as generated from the simulation model 200 in different operating scenario is used as the data input 2404. Further, in some embodiments, the tube pressure drop is input to the one or more machine learning classification algorithms. That is, the tube pressure drop can also be used as part of the data input 2404. Thereby, in the present examples, three features (variables) are used as input to the applied machine learning classification algorithm 2402, including the tube outlet temperature, the shell outlet temperature, and the tube pressure drop, while output is the segment (class).

Again, referring back to FIG. 1, at step 108, the method 100 includes determining the fouling location (as represented by block 2408 in FIG. 24) of the heat exchanger and a value of accumulated fouling at the fouling location based on the classified temperature data and the classified pressure drop data. In the present classification architecture 2400, the fouling location determination (or estimation/prediction) may be treated as a classification problem in which segments represent the class. In an embodiment, each of the multiple segments corresponds to one different class in the one or more machining learning classification algorithms, such as the applied machine learning classification algorithm 2402. In the present embodiments, the one or more machine learning classification algorithms can include, but are not limited to, at least one of a k-nearest neighbors algorithm, a decision tree algorithm, or a discriminant algorithm. That is, the applied machine learning classification algorithm 2402 can select one or more of the following machine learning algorithms to perform classification tasks: k-nearest neighbors, Decision Tree, and Discriminant algorithms using 10-fold cross-validation.

The results of utilizing the applied machine learning classification algorithm 2402 to determine (estimate/predict) the fouling location using the temperature data collected from the simulation model for five segments are discussed hereinafter. Table 3 (below) shows that the required accuracy is achieved to predict the fouling location. However, it may be observed that the present classification architecture 2400 provides high accuracy for predicting the fouling location in the ‘segment 5’ in all cases. Further, Table 4 (below) shows overall accuracy achieved by inputting the temperature data to the different machine learning classification algorithms on the temperature data. Further, it may be observed that the highest accuracy is obtained by implementing the k-nearest neighbors (KNN) algorithm, using the standardized temperature data 2406 (by normalization technique).

TABLE 3
Fouling Identification Result

| Algorithms | Accuracy | | | | |
|---|---|---|---|---|---|
| Segment | segment 1 | segment 1 | segment 3 | segment 4 | segment 5 |
| Number | | | | | |
| k-Nearest | 85.7% | 74.3% | 93.2% | 95.4% | 99.2% |
| Neighbors | | | | | |
| Decision Tree | 79.9% | 71.3% | 81.9% | 92.2% | 100% |
| Discriminant | 80.9% | 73.8% | 81.4% | 90.8% | 100% |

TABLE 4
Overall accuracy using different machine learning algorithms

| Algorithms | Overall Accuracy |
|---|---|
| k-nearest | 89.56% |
| neighbors | |
| Decision Tree | 85.06% |
| Discriminant | 85.38% |

In the present examples, the classification architecture 2400 is developed using the optimal parameters for each classifier. As discussed, the final results show that the KNN algorithm scored the highest accuracy. Furthermore, as discussed based on the previous results; the classification architecture 2400 achieves better prediction for the fouling location if the fouling occurred in the segment 5, which is at the end of the heat exchanger in the implemented simulation model 200 therefor. Therefore, the present method 100 may provide at least an indication of the fouling location which may be sufficient for an operator of the heat exchanger to plan the appropriate maintenance action.

In the above discussion, features are extracted from steady measurements for the prediction of the fouling location. According to aspects of the disclosure, a dynamic response of the heat exchanger is examined and features extracted from the dynamic response of the heat exchanger can also be used to predict the fouling location and the value of the accumulated fouling at the fouling location.

In an embodiment, the simulation model of the heat exchanger is excited with various input signals such as step input and/or sinusoidal input. One of the input signals can be a gas flow rate, a tube inlet temperature, or a shell inlet temperature.

In an embodiment, the features extracted from the dynamic response of the heat exchanger can include a transient response of an output signal of the simulation model. For example, the output signal can be tube outlet temperature, shell outlet temperature, or tube pressure drop.

In an embodiment, the transient response of the output signal can be a time constant or a rate of change of the output signal when a step signal is input to the simulation model.

In an embodiment, the transient response of the output signal can be an amplitude ratio or a phase shift between the output signal and the input signal when the excitation input signal is sinusoidal.

In an embodiment, at a certain level of fouling, the heat exchanger starts to behave in a nonlinear manner. Thus, the features extracted from the dynamic response of the heat exchanger can include a nonlinear response of the output signal, such as a frequency change between the output signal and the input signal, or output harmonics of the output signal.

According to aspects of the disclosure, additional features can be extracted by feeding the entire output signal (e.g., an entire transient part of the output signal) to a deep learning algorithm. Accordingly, these additional features can be combined together with the steady state features and the dynamic features to be used by a prediction model to predict the fouling location of the heat exchanger.

Again to summarize, the present disclosure provides heat exchanger analysis conducted using Petro-SIM simulator to investigate the effect of the fouling location. In particular, in the present disclosure, a shell and tube heat exchanger was divided into five segments in an example. Five scenarios were investigated where in each scenario fouling was added to one segment at a time. Simulation results shows that the fouling has more impact on outlet measurements when the fouling happens in segments which are closer to the heat exchanger outlet. Utilizing this observation, an artificial intelligence model was built that can estimate which of the segments has the fouling. The artificial intelligence model can provide an indication about the fouling location with a reasonable accuracy, which at least can be sufficient for an operator of the heat exchanger to understand if the fouling has been developed at the beginning, middle or at the end of the heat exchanger. It can be appreciated that the teachings of the present disclosure can further be extended to improve the accuracy of the artificial intelligence model to identify the fouling location more precisely, and further for the cases where more than one segment may have developed the fouling at the same time.

According to aspects of the disclosure, the method 100 can be implemented through various sensors in a chemical plant that monitor operation of a heat exchanger. For example, the physical property parameters and operation condition parameters of the heat exchanger can be obtained through the sensors. Based on the physical property parameters and operation condition parameters, a simulation model of the heat exchanger can be generated, and then the method 100 can be executed by, for example, processing circuitry 2501 of an apparatus 2500 for determining a fouling location of the heat exchanger. In an example, the physical property parameters can include, but are not limited to, shell inner diameter, tube inner diameter, tube outer diameter, the number of shell pass, the number of tubes, and tube length. In an example, the operation condition parameters can include, but are not limited to, shell fluid inlet temperature, tube fluid inlet temperature, shell fluid mass flow rate, and tube fluid mass flow rate.

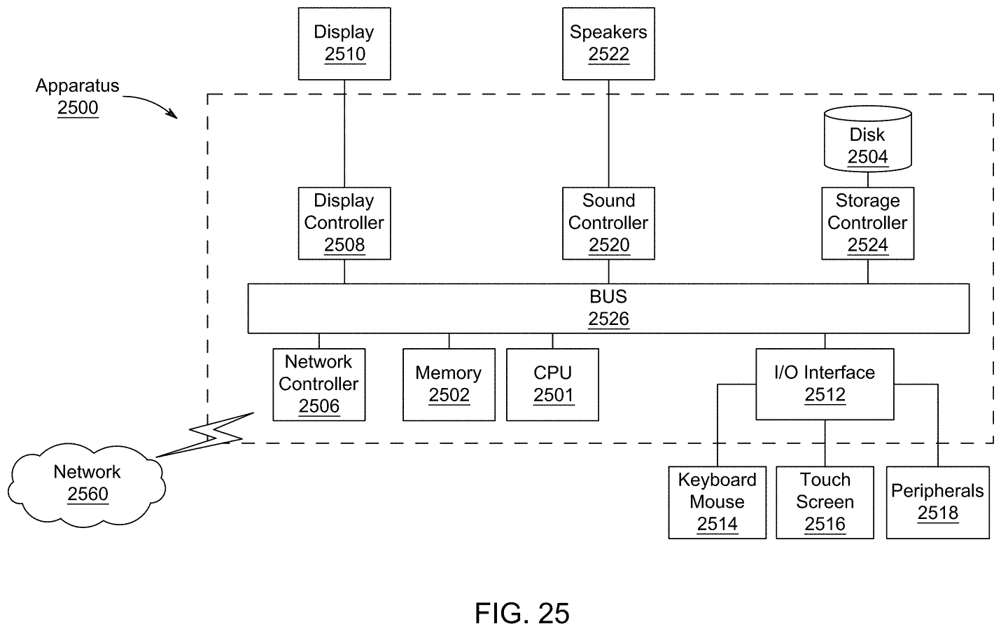

Further details of a hardware description for the apparatus 2500 according to exemplary embodiments are described with reference to FIG. 25. In FIG. 25, the apparatus 2500 is described which is representative of a computing device (with the two terms being interchangeably used hereinafter) for determining a fouling location of a shell and tube heat exchanger, in which the apparatus 2500 includes the processing circuitry 2501 (also referred to as CPU 2501) which performs the processes described above/below.

The processing circuitry 2501 is configured to partition a simulation model (such as, the simulation model 200) of the heat exchanger into multiple segments, each of the multiple segments corresponding to a different one of multiple operating scenarios of the heat exchanger. The processing circuitry 2501 is further configured to generate, for each of the multiple operating scenarios, temperature data and pressure drop data from the simulation model 200 of the heat exchanger, the fouling location of the heat exchanger corresponding to a respective segment in each of the multiple operating scenarios. The processing circuitry 2501 is further configured to classify the temperature data and the pressure drop data based on the multiple segments of the simulation model 200 of the heat exchanger by inputting the temperature data and the pressure drop data to one or more machine learning classification algorithms (such as, the applied machine learning classification algorithm 2402). The processing circuitry 2501 is further configured to determine the fouling location of the heat exchanger based on the classified temperature data and the classified pressure drop data.

In one embodiment, the one or more machine learning classification algorithms includes at least one of a k-nearest neighbors algorithm, a decision tree algorithm, or a discriminant algorithm.

In one embodiment, the temperature data is for at least one of a tube side or a shell side of the heat exchanger, and the pressure drop data is for the tube side of the heat exchanger.

In one embodiment, each of the multiple segments corresponds to one different class in the one or more machining learning classification algorithms.

In one embodiment, the processing circuitry is further configured to: change a tube inner diameter and a heat transfer coefficient of one of the multiple segments corresponding to the fouling location to generate the value of the accumulated fouling at the fouling location; and keep tube inner diameters and heat transfer coefficients of other segments unchanged.

In one embodiment, a number of samples used in each operating scenario is around 400.

In one embodiment, a number of the multiple segments is around 5.

In one embodiment, tube pressure drop data is input to the one or more machine learning classification algorithms.

In one embodiment, the processing circuitry is also configured to determine the fouling location of the heat exchanger and the value of the accumulated fouling at the fouling location based on features extracted from a dynamic response of the simulation model of the heat exchanger.

In one embodiment, the dynamic response of the simulation model is obtained by inputting a step or sinusoidal form of an input signal that is a gas flow rate, a tube inlet temperature, or a shell inlet temperature.

In one embodiment, the features extracted from the dynamic response of the simulation model include at least one of a rate of change, a time constant, an amplitude ratio, a phase shift, or output harmonics of an output signal of the simulation model.

In one embodiment, the output signal is a tube outlet temperature, a shell outlet temperature, or a tube pressure drop.

In one embodiment, the features extracted from the dynamic response of the simulation model are generated by feeding an entire output signal of the simulation model to a deep learning algorithm.

The two types of heat exchangers are classified as co-current and counter-current based on flow direction (see S. Heo in “Nonlinear control of high duty counter-current heat exchangers using reduced order model,” Appl. Therm. Eng., vol. 157, 2019). Fouling is an accumulation of undesired materials on an inner surface of a heat exchanger producing a rise in the thermal resistance of the heat exchanger and/or restricting the flow of material through the heat exchanger. Foulants, both organic and inorganic, usually have a poor thermal conductivity compared to the conductivity of the metallic walls of heat exchanger tubes. Fouling thus results in a degradation of the heat transfer rate. Moreover, fouling forms a deposit that physically restricts fluid flow through the heat exchanger.

A lot of research in the literature has been devoted to fouling estimation and prediction, which is useful for maintenance planning and can avoid unplanned shutdown to clean heat exchangers. Nevertheless, it is not always economically feasible to shut down the process in order to perform cleaning and remove foulants. Often a fouled heat exchanger must be operated in a compromised state. Even if a fouled heat exchanger is taken off-line for repair, identifying the location of the foulant can be a time consuming and costly process thus further impacting the operational status of the process in which the heat exchanger is employed.

In a preferred embodiment the process described herein is used to identify the location of fouling in a heat exchanger thereby permitting efficient maintenance to remove a foulant from a tube of a heat exchanger, e.g., by quick cleaning of only the fouled location instead of an entire collection of tubes.

As illustrated in FIG. 25, the process data and instructions may be stored in a memory 1302. These processes and instructions may also be stored on a storage medium disk 2504 such as a hard drive (HDD) or portable storage medium or may be stored remotely. Such storage medium disk 2504 may be any non-transitory computer-readable storage medium which stores a program executable by at least one processor to perform the described functions in the preceding paragraphs. It may be appreciated that the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with the CPU 2501 and an operating system such as Microsoft Windows 7, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, the CPU 2501 may be a Xenon or Core processor from Intel of America or an Opteron processor from AMD of America, or may be other processor types that would be recognized by one of ordinary skill in the art. Alternatively, the CPU 2501 may be implemented on an FPGA, ASIC, PLD or using discrete logic circuits, as one of ordinary skill in the art would recognize. Further, the CPU 2501 may be implemented as multiple processors cooperatively working in parallel to perform the instructions of the inventive processes described above.

The computing device in FIG. 25 also includes a network controller 2506, such as an Intel Ethernet PRO network interface card from Intel Corporation of America, for interfacing with network 2560. As can be appreciated, the network 2560 can be a public network, such as the Internet, or a private network such as an LAN or WAN network, or any combination thereof and can also include PSTN or ISDN sub-networks. The network 2560 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 2508, such as a NVIDIA GeForce GTX or Quadro graphics adaptor from NVIDIA Corporation of America for interfacing with display 2510, such as a Hewlett Packard HPL2445w LCD monitor. A general purpose I/O interface 2512 may also be provided.

A sound controller 2520 is also provided in the computing device such as Sound Blaster X-Fi Titanium from Creative, to interface with speakers/microphone 2522 thereby providing sounds and/or music.

The general purpose storage controller 2524 connects the storage medium disk 2504 with communication bus 2526, which may be an ISA, EISA, VESA, PCI, or similar, for interconnecting all of the components of the computing device. A description of the general features and functionality of the display 2510, keyboard and/or mouse 2514, as well as the display controller 2508, storage controller 2524, network controller 2506, sound controller 2520, and general purpose I/O interface 2512 is omitted herein for brevity as these features are known.

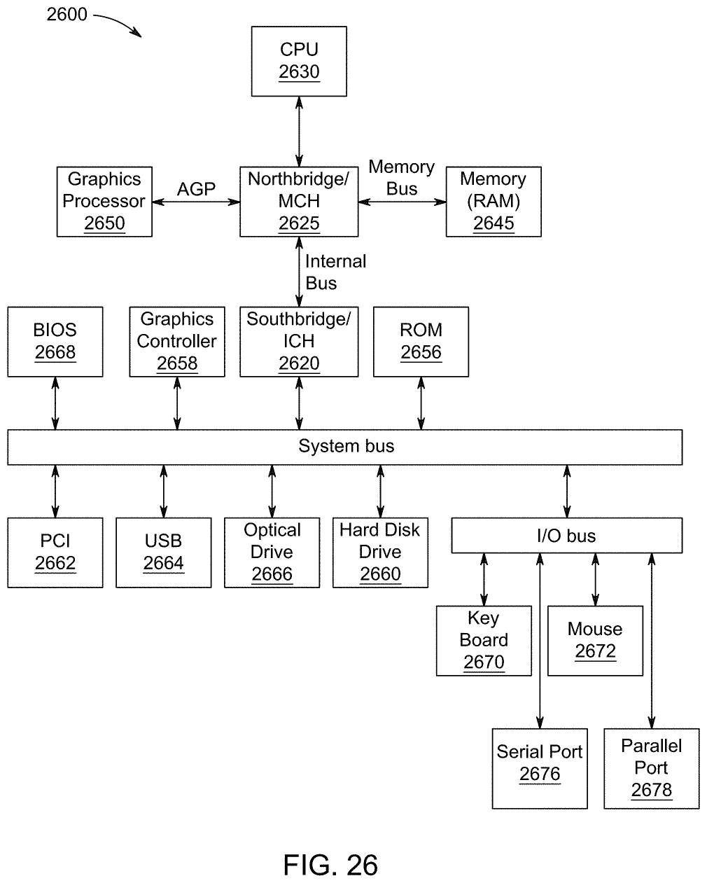

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 26.

FIG. 26 shows a schematic diagram of a data processing system 2600, according to certain embodiments, for performing the functions of the exemplary embodiments. The data processing system 2600 is an example of a computer in which code or instructions implementing the processes of the illustrative embodiments may be located.

In FIG. 26, the data processing system 2600 employs a hub architecture including a north bridge and memory controller hub (NB/MCH) 2625 and a south bridge and input/output (I/O) controller hub (SB/ICH) 2620. The central processing unit (CPU) 2630 is connected to NB/MCH 2625. The NB/MCH 2625 also connects to the memory 2645 via a memory bus, and connects to the graphics processor 2650 via an accelerated graphics port (AGP). The NB/MCH 2625 also connects to the SB/ICH 2620 via an internal bus (e.g., a unified media interface or a direct media interface). The CPU Processing unit 2630 may contain one or more processors and even may be implemented using one or more heterogeneous processor systems.

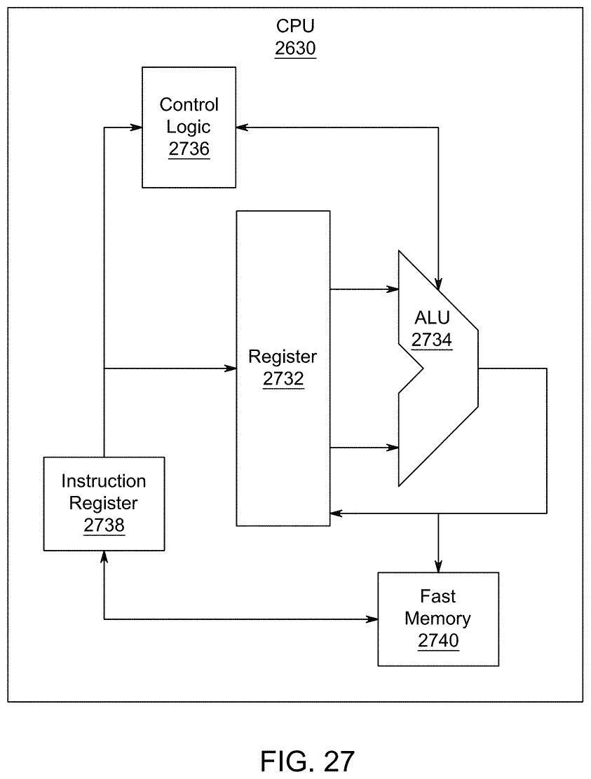

For example, FIG. 27 shows one implementation of CPU 2630. In one implementation, the instruction register 2738 retrieves instructions from the fast memory 2740. At least part of these instructions are fetched from the instruction register 2738 by the control logic 2736 and interpreted according to the instruction set architecture of the CPU 2630. Part of the instructions can also be directed to the register 2732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 2734 that loads values from the register 2732 and performs logical and mathematical operations on the loaded values according to the instructions. The results from these operations can be feedback into the register and/or stored in the fast memory 2740. According to certain implementations, the instruction set architecture of the CPU 2630 can use a reduced instruction set architecture, a complex instruction set architecture, a vector processor architecture, a very large instruction word architecture. Furthermore, the CPU 2630 can be standard on the Von Neuman model or the Harvard model. The CPU 2630 can be a digital signal processor, an FPGA, an ASIC, a PLA, a PLD, or a CPLD. Further, the CPU 2630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 26, the data processing system 2600 can include that the SB/ICH 2620 is coupled through a system bus to an I/O Bus, a read only memory (ROM) 2656, universal serial bus (USB) port 2664, a flash binary input/output system (BIOS) 2668, and a graphics controller 2658. PCI/PCIe devices can also be coupled to SB/ICH 888 through a PCI bus 2662.

The PCI devices may include, for example, Ethernet adapters, add-in cards, and PC cards for notebook computers. The Hard disk drive 2660 and CD-ROM 2666 can use, for example, an integrated drive electronics (IDE) or serial advanced technology attachment (SATA) interface. In one implementation the I/O bus can include a super I/O (SIO) device.

Further, the hard disk drive (HDD) 2660 and optical drive 2666 can also be coupled to the SB/ICH 2620 through a system bus. In one implementation, a keyboard 2670, a mouse 2672, a parallel port 2678, and a serial port 2676 can be connected to the system bus through the I/O bus. Other peripherals and devices that can be connected to the SB/ICH 2620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted standard on changes on battery sizing and chemistry, or standard on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Obviously, numerous modifications and variations of the present disclosure are possible in light of the above teachings. It is therefore to be understood that within the scope of the appended claims, the invention may be practiced otherwise than as specifically described herein.

1. A method of determining a fouling location of a shell and tube heat exchanger, the method comprising:
partitioning a simulation model of the heat exchanger into multiple segments, each of the multiple segments corresponding to a different one of multiple operating scenarios of the heat exchanger;
generating, for each of the multiple operating scenarios, temperature data and pressure drop data from the simulation model of the heat exchanger, the fouling location of the heat exchanger corresponding to a respective segment in each of the multiple operating scenarios;
classifying the temperature data and the pressure drop data based on the multiple segments of the simulation model of the heat exchanger by inputting the temperature data and the pressure drop data to one or more machine learning classification algorithms; and
determining the fouling location of the heat exchanger and a value of accumulated fouling at the fouling location based on the classified temperature data and the classified pressure drop data.

2. The method of claim 1, wherein the one or more machine learning classification algorithms includes at least one of a k-nearest neighbors algorithm, a decision tree algorithm, or a discriminant algorithm.

3. The method of claim 1, wherein the temperature data is for at least one of a tube side or a shell side of the heat exchanger, and the pressure drop data is for the tube side of the heat exchanger.

4. The method of claim 1, wherein each of the multiple segments corresponds to one different class in the one or more machining learning classification algorithms.

5. The method of claim 1, wherein the generating includes:
changing a tube inner diameter and a heat transfer coefficient of one of the multiple segments corresponding to the fouling location to generate the value of the accumulated fouling at the fouling location; and
keeping tube inner diameters and heat transfer coefficients of other segments unchanged.

6. The method of claim 1, wherein the determining further comprises:
determining the fouling location of the heat exchanger and the value of the accumulated fouling at the fouling location based on features extracted from a dynamic response of the simulation model of the heat exchanger.

7. The method of claim 6, wherein the dynamic response of the simulation model is obtained by inputting a step or sinusoidal form of an input signal that is a gas flow rate, a tube inlet temperature, or a shell inlet temperature.

8. The method of claim 6, wherein the features extracted from the dynamic response of the simulation model include at least one of a rate of change, a time constant, an amplitude ratio, a phase shift, or output harmonics of an output signal of the simulation model.

9. The method of claim 8, wherein the output signal is a tube outlet temperature, a shell outlet temperature, or a tube pressure drop.

10. The method of claim 6, wherein the features extracted from the dynamic response of the simulation model are generated by feeding an entire output signal of the simulation model to a deep learning algorithm.

11. An apparatus for determining a fouling location of a shell and tube heat exchanger, the apparatus comprising processing circuitry configured to:
partition a simulation model of the heat exchanger into multiple segments, each of the multiple segments corresponding to a different one of multiple operating scenarios of the heat exchanger;
generate, for each of the multiple operating scenarios, temperature data and pressure drop data from the simulation model of the heat exchanger, the fouling location of the heat exchanger corresponding to a respective segment in each of the multiple operating scenarios;
classify the temperature data and the pressure drop data based on the multiple segments of the simulation model of the heat exchanger by inputting the temperature data and the pressure drop data to one or more machine learning classification algorithms; and
determine the fouling location of the heat exchanger and a value of accumulated fouling at the fouling location based on the classified temperature data and the classified pressure drop data.

12. The apparatus of claim 11, wherein the one or more machine learning classification algorithms includes at least one of a k-nearest neighbors algorithm, a decision tree algorithm, or a discriminant algorithm.

13. The apparatus of claim 11, wherein the temperature data is for at least one of a tube side or a shell side of the heat exchanger, and the pressure drop data is for the tube side of the heat exchanger.

14. The apparatus of claim 11, wherein each of the multiple segments corresponds to one different class in the one or more machining learning classification algorithms.

15. The apparatus of claim 11, wherein the processing circuitry is further configured to:
change a tube inner diameter and a heat transfer coefficient of one of the multiple segments corresponding to the fouling location to generate the value of the accumulated fouling at the fouling location; and
keep tube inner diameters and heat transfer coefficients of other segments unchanged.

16. The apparatus of claim 11, wherein the processing circuitry is further configured to:
determine the fouling location of the heat exchanger and the value of the accumulated fouling at the fouling location based on features extracted from a dynamic response of the simulation model of the heat exchanger.

17. The apparatus of claim 16, wherein the dynamic response of the simulation model is obtained by inputting a step or sinusoidal form of an input signal that is a gas flow rate, a tube inlet temperature, or a shell inlet temperature.

18. The apparatus of claim 16, wherein the features extracted from the dynamic response of the simulation model include at least one of a rate of change, a time constant, an amplitude ratio, a phase shift, or output harmonics of an output signal of the simulation model.

19. The apparatus of claim 18, wherein the output signal is a tube outlet temperature, a shell outlet temperature, or a tube pressure drop.

20. A non-transitory computer-readable storage medium storing a program executable by at least one processor to perform:
partitioning a simulation model of a heat exchanger into multiple segments, each of the multiple segments corresponding to a different one of multiple operating scenarios of the heat exchanger;
generating, for each of the multiple operating scenarios, temperature data and pressure drop data from the simulation model of the heat exchanger, the fouling location of the heat exchanger corresponding to a respective segment in each of the multiple operating scenarios;
classifying the temperature data and the pressure drop data based on the multiple segments of the simulation model of the heat exchanger by inputting the temperature data and the pressure drop data to one or more machine learning classification algorithms; and
determining the fouling location of the heat exchanger and a value of accumulated fouling at the fouling location based on the classified temperature data and the classified pressure drop data.
